(19) United States
(12) Patent Application Publication
(10) Pub. No.: US 2024/0139692 A1
(43) Pub. Date: May 2, 2024

(54) BEVERAGE AERATOR DEVICES

(71) Applicant: Gideon Vandegrift, Sarasota, FL (US)

(72) Inventor: Gideon Vandegrift, Sarasota, FL (US)

(21) Appl. No.: 18/498,710

(22) Filed: Oct. 31, 2023

Related U.S. Application Data
(60) Provisional application No. 63/381,853, filed on Nov. 1, 2022.

(51) Int. Cl. B01F 23/2361; A23L 2/54; B01F 33/501

(52) U.S. Cl. CPC B01F 23/2361; A23L 2/54; B01F 33/50111; B01F 2101/17

(57) ABSTRACT

Disclosed herein are beverage aerator devices that include a body that has a top surface and a bottom surface. At least one choke extends through the body and has a choke inlet at the bottom surface of the body and a choke outlet at the top surface of the body. A pressure exchange extends through the body and has a pressure exchange outlet at the top surface of the body. A pressure exchange tube is in fluid communication with the pressure exchange and has a pressure exchange inlet distal from the bottom surface of the body.

### CROSS-REFERENCE TO RELATED APPLICATIONS

This application claims the benefit of U.S. Provisional Patent Application Ser. No. 63/381,853, filed Nov. 1, 2022, entitled “VENTURI AERATOR,” which is hereby incorporated by reference in its entirety including the drawings.

### BACKGROUND

Certain types of beverages may benefit from aeration, that is, contact with air, to enhance aroma, flavor, and overall drinking experience. For example, wine aeration is a crucial aspect of wine appreciation and the process of allowing wine to come into contact with air can significantly impact its flavor and aroma profile. Aeration can trigger various chemical reactions, such as, in wine for example, the oxidation of certain compounds like sulfites and volatile organic compounds, which can reduce undesirable aromas and enhance more desirable aromas. Wine or other beverages are typically aerated by decanting into a wide-bottomed container or by allowing the beverage to breathe in a glass. However, aeration is a balancing act, as too much exposure to oxygen can have detrimental effects on the beverage such as premature aging, dulling of flavors, and spoilage. Moreover, the aeration process for some beverages can take up to an hour or longer.

Accordingly, a need exists for improved aeration devices and processes that mix the beverage with air as the beverage is poured.

### SUMMARY

The present disclosure relates to an apparatus, method of use, and method of manufacturing related to a beverage aerator device that utilizes the Venturi effect to aerate the beverage (hereinafter referred to as “Venturi Aerator” or “beverage aerator device”). In certain embodiments, this Venturi Aerator can be used to aerate beverages such as wine and can be included as a pre-packaged unit inside bottles such as wine bottles. In other words, unlike traditional wine aerators (which a user separately purchases then either affixes to a wine bottle or pours wine into), the Venturi Aerator of the present disclosure allows a user to aerate wine simply by emptying a wine bottle.

In some embodiments, the beverage aerator device of the present disclosure includes a body that has a top surface and a bottom surface; at least one choke that extends through the body and has a choke inlet at the bottom surface of the body and a choke outlet at the top surface of the body; a pressure exchange that extends through the body and has a pressure exchange outlet at the top surface of the body; and a pressure exchange tube that is in fluid communication with the pressure exchange and has a pressure exchange inlet distal from the bottom surface of the body.

In other embodiments, the beverage aerator device of the present disclosure includes a cylindrical body that has a top surface and a bottom surface, wherein the cylindrical body is frictionally engaged inside a neck of a bottle; a pressure exchange tube extending outwards from the bottom surface of the cylindrical body that has a pressure exchange inlet distal from the bottom surface of the cylindrical body and a pressure exchange outlet at the top surface of the cylindrical body, wherein the pressure exchange tube extends into a body-portion of the bottle; and at least one choke that extends through the cylindrical body, the at least one choke having a choke inlet at the bottom surface of the cylindrical body, a choke outlet at the top surface of the cylindrical body, and a constricted section disposed adjacent to the choke inlet.

In additional embodiments, a method of using the beverage aerator device of the present disclosure includes inserting the beverage aerator device into a neck of a bottle containing a fluid, the beverage aerator device including: a body that has a top surface and a bottom surface; a pressure exchange tube that has a pressure exchange inlet distal from the bottom surface of the body and a pressure exchange outlet at the top surface of the body; and at least one choke that extends through the body and includes a choke inlet at the bottom surface of the body, a choke outlet at the top surface of the body, and a constricted section disposed adjacent to the choke inlet; causing the fluid to flow from the bottle into the choke inlet of the at least one choke of the body; aerating the fluid at the constricted section of the at least one choke to create a mixture of the fluid with air; and pouring the mixture of the fluid with the air from the choke outlet of the at least one choke of the body.

In certain embodiments, the Venturi Aerator of the present disclosure can be embedded (e.g., via frictional engagement) within a neck of a wine bottle. A closure (such as a natural cork or a synthetic cork) can then be placed above the Venturi Aerator, and the bottle sealed normally (such as adding a capsule, e.g., a wrapping around the enclosure). After the bottle is purchased by an end-user, the end-user can open the bottle in the normal fashion (e.g., removing the capsule and using a corkscrew to remove the closure). The Venturi Aerator will remain engaged in the neck of the bottle and will aerate wine as such wine flows through the Venturi Aerator.

In certain embodiments, the Venturi Aerator can also accommodate bottles sealed with a twist-off cap. In such embodiments, the Venturi Aerator has the capability of being located further up the neck of the bottle.

In certain embodiments, the Venturi Aerator can be inserted into the base of the neck of a wine bottle—allowing room for a closure (such as a cork or a synthetic cork) to be inserted into the neck of the bottle above the Venturi Aerator. In other embodiments (e.g., in wine bottles having a screw cap), the Venturi Aerator can be inserted into the top of the neck of a wine bottle—resulting in the Venturi Aerator being flush (or slightly below) the top of the wine bottle).

In certain embodiments, the Venturi Aerator can be inserted into a pre-filled bottle by an end user. For example, an end user could purchase a standard bottle of wine, remove the closure (such as a cork or a synthetic cork) using a corkscrew or remove the twist off cap (for bottles with a screw cap). The user could then insert a Venturi Aerator into the neck of the wine bottle, and pour the wine into a glass—aerating the wine as it passes through the Venturi Aerator.

In additional embodiments, a method of filling a bottle includes: (a) having a sterilized bottle; (b) inserting a sterilized Venturi Aerator into the bottle; (c) filling the bottle with a liquid; and (d) sealing the bottle. The method of filling a bottle further includes: (a1) wherein the bottle is a wine bottle. The method of filling a bottle further includes: (b1) the sterilized Venturi Aerator is inserted into the neck of the bottle. The method of filling a bottle further includes: (c1) wherein the liquid is a beverage. The method of filling a bottle further includes: (c2) wherein the liquid is wine. The method of filling a bottle further includes: (c3) wherein the liquid is a distilled spirit. The method of filling a bottle further includes: (d1) wherein the bottle is sealed with a closure (such as a cork or a synthetic cork). The method of filling a bottle further includes: (d2) wherein the bottle is sealed with a screw cap.

In further embodiments, a method of filling a bottle includes: (a) having a sterilized bottle; (b) filing the sterilized bottle with a liquid; (c) inserting a sterilized Venturi Aerator into the bottle; and (d) sealing the bottle. The method of filling a bottle further includes: (a1) wherein the bottle is a wine bottle. The method of filling a bottle further includes: (b1) wherein the liquid is a beverage. The method of filling a bottle further includes: (b2) wherein the liquid is wine. The method of filling a bottle further includes: (b3) wherein the liquid is a distilled spirit. The method of filling a bottle further includes: (c1) the sterilized Venturi Aerator is inserted into the neck of the bottle. The method of filling a bottle further includes: (d1) wherein the bottle is sealed with a closure (such as a cork or a synthetic cork). The method of filling a bottle further includes: (d2) wherein the bottle is sealed with a screw cap.

In some embodiments, a method of filling a bottle includes: (a) having a bottle; (b) inserting a Venturi Aerator into the bottle; (c) sterilizing the bottle and Venturi Aerator assembly; (d) filing the sterilized bottle with a liquid; and (e) sealing the bottle. The method of filling a bottle further includes: (a1) wherein the bottle is a wine bottle. The method of filling a bottle further includes: (b1) the Venturi Aerator is inserted into the neck of the bottle. The method of filling a bottle further includes: (d1) wherein the liquid is a beverage. The method of filling a bottle further includes: (d2) wherein the liquid is wine. The method of filling a bottle further includes: (d3) wherein the liquid is a distilled spirit. The method of filling a bottle further includes: (e1) wherein the bottle is sealed with a closure (such as a cork or a synthetic cork). The method of filling a bottle further includes: (e2) wherein the bottle is sealed with a screw cap.

In some additional embodiments, a method of aerating a bottled liquid includes: (a) having a pre-filled bottle of liquid; (b) opening the bottle; (c) inserting a Venturi Aerator into the bottle; and (d) pouring the liquid through the Venturi Aerator. The method of aerating a bottled liquid further includes: (a1) wherein the bottle is a wine bottle. The method of aerating a bottled liquid further includes: (b1) wherein the bottle is opened by removing a closure (such as a cork or a synthetic cork). The method of aerating a bottled liquid further includes: (b2) wherein the bottle is opened by removing a screw cap. The method of aerating a bottled liquid further includes: (d1) wherein the liquid is a beverage. The method of aerating a bottled liquid further includes: (d2) wherein the liquid is wine. The method of aerating a bottled liquid further includes: (d3) wherein the liquid is a distilled spirit.

In some further embodiments, a method of aerating a liquid includes passing the liquid through a Venturi Aerator. The method of aerating a liquid further includes: wherein the liquid is a beverage. The method of aerating a liquid further includes: wherein the liquid is wine. The method of aerating a liquid further includes: wherein the liquid is a distilled spirit.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a front, perspective view of one embodiment of a Venturi Aerator having a body, two chokes and a pressure exchange tube;

FIG. 1B depicts an enlarged detail of a front, perspective view of one embodiment of a Venturi Aerator having a body, two chokes and a pressure exchange tube;

FIG. 1C depicts a rear, perspective view of one embodiment of a Venturi Aerator having a body, two chokes and a pressure exchange tube;

FIG. 1D depicts a cutaway, rear, perspective view of one embodiment of a Venturi Aerator having a body, two chokes and a pressure exchange tube;

FIG. 1E depicts an enlarged detail of a cutaway, rear, perspective view of one embodiment of a Venturi Aerator having a body, two chokes and a pressure exchange tube;

FIG. 1F depicts a cutaway, side view of one embodiment of a Venturi Aerator having a body, two chokes and a pressure exchange tube;

FIG. 1G depicts a cutaway, front, perspective view of one embodiment of a Venturi Aerator having a body, two chokes and a pressure exchange tube;

FIG. 2A depicts a side view of one embodiment of a closure and a Venturi Aerator;

FIG. 2B depicts a cutaway, side view of one embodiment of a closure and a Venturi Aerator;

FIG. 2C depicts a cutaway, rear, perspective view of one embodiment of a closure and a Venturi Aerator;

FIG. 3A depicts a side, cutaway view of a bottle with a side (non-cutaway) view of one embodiment of a closure and a Venturi Aerator;

FIG. 3B depicts a cutaway, bottom, perspective view of a bottle with a bottom, perspective (non-cutaway) view of one embodiment of a closure and a Venturi Aerator;

FIG. 3C depicts a cutaway, top, perspective view of a bottle with a top, perspective (non-cutaway) view of one embodiment of a closure and a Venturi Aerator;

FIG. 3D depicts a depicts a cutaway, side view of a bottle with one embodiment of a closure and a Venturi Aerator;

FIG. 3E depicts a cutaway, bottom, perspective view of a bottle with one embodiment of a closure and a Venturi Aerator;

FIG. 3F depicts a cutaway, top, perspective view of a bottle (with no closure) with a top, perspective (non-cutaway) view of one embodiment of a Venturi Aerator;

FIG. 3G depicts a cutaway, bottom, perspective view of a bottle (with no closure) with one embodiment of a Venturi Aerator;

FIG. 3H depicts a cutaway, side view of a bottle (with no closure) with one embodiment of a Venturi Aerator;

FIG. 4A depicts a cutaway, side view of a screw cap bottle with a side (non-cutaway) view of one embodiment of a Venturi Aerator;

FIG. 4B depicts a cutaway, top, perspective view of a screw cap bottle with a top, perspective (non-cutaway) view of one embodiment of a Venturi Aerator;

FIG. 4C depicts a cutaway, bottom, perspective view of a screw cap bottle with a bottom, perspective (non-cutaway) view of one embodiment of a Venturi Aerator;

FIG. 4D depicts a cutaway, side view of a screw cap bottle with one embodiment of a Venturi Aerator;

FIG. 4E depicts a cutaway, bottom, perspective view of a screw cap bottle with one embodiment of a Venturi Aerator;

FIG. 4F depicts a cutaway, bottom, perspective, view of a screw cap bottle (with no cap) with one embodiment of a Venturi Aerator;

FIG. 5A depicts a front, perspective view of one embodiment of a Venturi Aerator having a body, three chokes and a pressure exchange tube;

FIG. 5B depicts an enlarged detail of a front, perspective view of one embodiment of a Venturi Aerator having a body, three chokes and a pressure exchange tube;

FIG. 5C depicts a rear, perspective view of one embodiment of a Venturi Aerator having a body, three chokes and a pressure exchange tube;

FIG. 5D depicts an enlarged detail of a rear, perspective view of one embodiment of a Venturi Aerator having a body, three chokes and a pressure exchange tube;

FIG. 5E depicts a perspective view of one embodiment of a Venturi Aerator having a body, three chokes and a pressure exchange tube;

FIG. 5F depicts a perspective view of one embodiment of a Venturi Aerator having a body, three chokes and a pressure exchange tube;

FIG. 5G depicts a perspective view of one embodiment of a Venturi Aerator having a body, three chokes and a pressure exchange tube;

FIG. 5H depicts a cutaway, perspective view of one embodiment of a Venturi Aerator having a body, three chokes and a pressure exchange tube;

FIG. 5I depicts a cutaway, front view of one embodiment of a Venturi Aerator having a body, three chokes and a pressure exchange tube;

FIG. 5J depicts a rear, perspective view of one embodiment of a Venturi Aerator having a body, three chokes and a pressure exchange tube;

FIG. 6A depicts a perspective view of an embodiment of a Venturi Aerator having a body, two chokes and a pressure exchange tube inserted into a wine bottle. The wine bottle is partially filled with wine and is adjacent to an empty wine glass;

FIG. 6B depicts a perspective view of a user pouring wine using an embodiment of a Venturi Aerator which has been inserted into a wine bottle;

FIG. 6C depicts a perspective view of a wine glass filled with wine aerated by a Venturi Aerator;

FIG. 7A depicts a diagram showing a potential configuration of an embodiment of a Venturi Aerator having one choke;

FIG. 7B depicts a diagram showing a potential configuration of an embodiment of a Venturi Aerator having one choke;

FIG. 7C depicts a diagram showing a potential configuration of an embodiment of a Venturi Aerator having one choke;

FIG. 7D depicts a diagram showing a potential configuration of an embodiment of a Venturi Aerator having one choke;

FIG. 8A depicts a diagram showing a potential configuration of an embodiment of a Venturi Aerator having two chokes;

FIG. 8B depicts a diagram showing a potential configuration of an embodiment of a Venturi Aerator having two chokes;

FIG. 9 depicts a diagram showing a potential configuration of an embodiment of a Venturi Aerator having three chokes;

FIG. 10A depicts a cutaway perspective view of a bottle with a bottom, perspective (non-cutaway) view of one embodiment of a Venturi Aerator;

FIG. 10B depicts a cutaway perspective view of a bottle with a bottom, perspective cutaway view of one embodiment of a Venturi Aerator;

FIG. 10C depicts a cutaway perspective view of a bottle with a bottom, perspective cutaway view of one embodiment of a Venturi Aerator;

FIG. 10D depicts a bottom perspective (non-cutaway) view of one embodiment of a Venturi Aerator;

FIG. 10E depicts a bottom cutaway perspective view of one embodiment of a Venturi Aerator;

FIG. 10F depicts a top perspective (non-cutaway) view of one embodiment of a Venturi Aerator;

FIG. 10G depicts a top cutaway perspective view of one embodiment of a Venturi Aerator;

FIG. 10H depicts a side perspective (non-cutaway) view of one embodiment of a Venturi Aerator;

FIG. 10I depicts a side (non-cutaway) view of one embodiment of a Venturi Aerator;

FIG. 10J depicts a side (non-cutaway) view of one embodiment of a Venturi Aerator;

FIG. 10K depicts a top view of one embodiment of a Venturi Aerator having a body, two chokes and a pressure exchange tube;

FIG. 11A depicts a top perspective view of one part of an embodiment of a Venturi Aerator having a two-part construction;

FIG. 11B depicts a side view of one part of an embodiment of a Venturi Aerator having a two-part construction;

FIG. 11C depicts a top cutaway perspective view of one part of an embodiment of a Venturi Aerator having a two-part construction;

FIG. 11D depicts a bottom perspective view of one part of an embodiment of a Venturi Aerator having a two-part construction;

FIG. 11E depicts a top view of one part of an embodiment of a Venturi Aerator having a two-part construction, the one part having a body, two chokes and a pressure exchange tube;

FIG. 11F depicts a top perspective view of another part of an embodiment of a Venturi Aerator having a two-part construction;

FIG. 11G depicts a bottom perspective view of another part of an embodiment of a Venturi Aerator having a two-part construction;

FIG. 11H depicts a top perspective view of another part of an embodiment of a Venturi Aerator having a two-part construction; and

FIG. 11I depicts a top cutaway perspective view of another part of an embodiment of a Venturi Aerator having a two-part construction.

### DETAILED DESCRIPTION

Embodiments described herein are directed to an apparatus, method of use, and method of manufacturing related to a Venturi Aerator device that utilizes the Venturi effect in one or more chokes to aerate a beverage being poured from a bottle. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

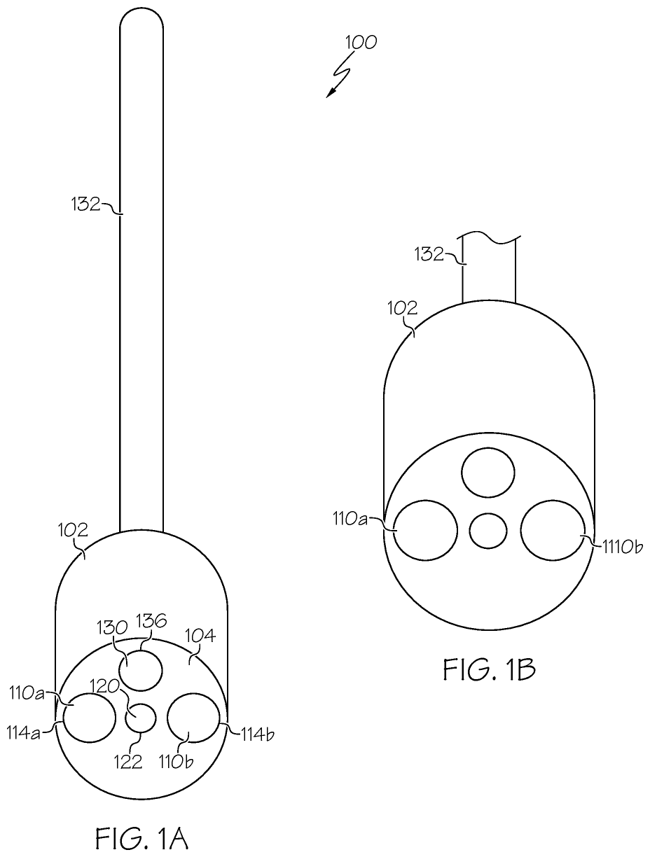

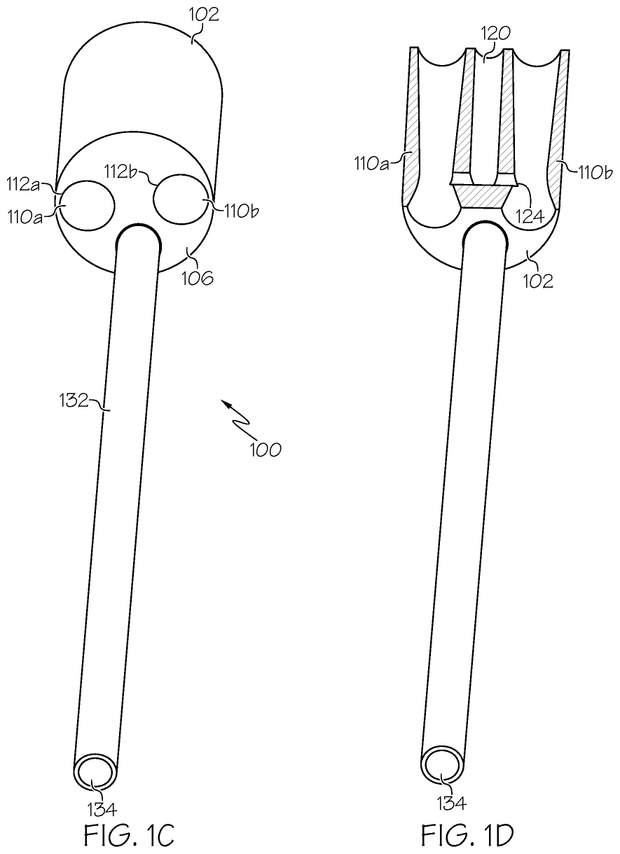

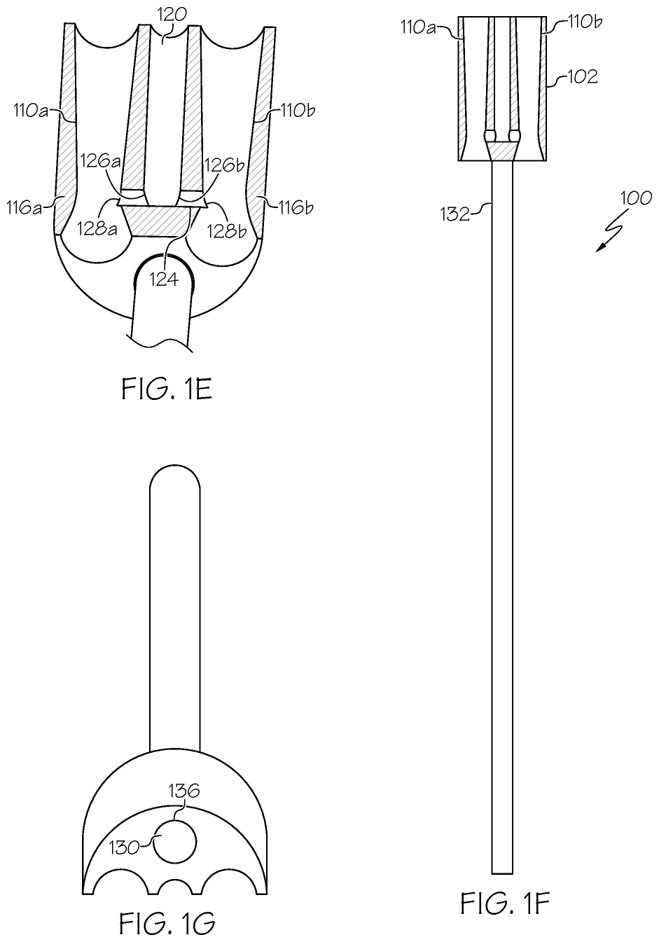

FIG. 1A depicts a front, perspective view of one embodiment of a Venturi Aerator 100 having a Body 102, two Chokes 110a, 110b and a Pressure Exchange Tube 132. In the embodiment shown in FIG. 1A, the Body 102 has a generally cylindrical shape dimensionally sized to fit inside a bottle. In certain embodiments, the Body 102 frictionally engages inside the neck of a wine or liquor bottle (not shown in FIG. 1A). In certain embodiments, the Body 102 is dimensionally sized to match a Number 7, 8, 9 or 10 size cork. The Body 102 may be constructed of any food grade material. In certain embodiments, the Body 102 is made out of food grade plastics or food grade synthetic cork material such as low-density polyethylene (“LDPE”). In certain embodiments, the Body 102 may be manufactured by injection molding. In certain embodiments, the Body 102 may be manufactured by 3D printing.

In the embodiment shown in FIG. 1A, the Body 102 has a Top Surface 104 and a distal Bottom Surface 106 (not shown in FIG. 1A). At least one Choke 110a, 110b extends through the Body 102, with the Choke 110b, 110b having a Choke Outlet 114a, 114b at the Top Surface 104 and a Choke Inlet 112a, 112b (not shown in FIG. 1A) at the Bottom Surface 106 (not shown in FIG. 1A). In the embodiment shown in FIG. 1A, the Venturi Aerator 100 has two Chokes 110a and 110b. As noted above, however, embodiments having only one Choke or a plurality of Chokes are possible. In the embodiment shown in FIG. 1A, the Venturi Aerator 100 also has at least one Pressure Exchange 130 that extends through the Body 102 with at least one Pressure Exchange Outlet 136 at the Top Surface 104 of the Body 102. This Pressure Exchange 130 is in fluid communication with a Pressure Exchange Tube 132 which extends outwards from the Bottom Surface 106 (not shown in FIG. 1A) of the Body 102. The purpose of the Pressure Exchange 130 is to equalize the pressure inside the bottle with the outside air pressure. This allows for a smooth flow of liquid as air bubbles into the bottle through the Pressure Exchange Tube 132 as liquid pours out of the Bottle. In certain embodiments, the Pressure Exchange Tube 132 extends into the body-portion of a bottle. In certain embodiments, the Pressure Exchange Tube 132 extends approximately one inch beyond the Body 102 of the Venturi Aerator 100. In certain embodiments, the Body 102 of the Venturi Aerator 100 is approximately 3¼ inches in length. The Pressure Exchange Tube 132 may be formed of any food-grade material. In the preferred embodiment, the Pressure Exchange Tube 132 is made of a plastic so that it is shatter-resistant. In the embodiment shown in FIG. 1A, the Venturi Aerator 100 also has an Air Manifold 120 extending partially into the Body 102 with a Manifold Aperture 122 at the Top Surface 104. In the embodiment shown in FIG. 1A, the Air Manifold 120 is shown as centrally located in the Body 102. In other embodiments, however, the Air Manifold 120 may be offset from the center, i.e., it may be in another position in the Body 102. The relative size of each Choke Outlet 114a, 114b, Manifold Aperture 122 and Pressure Exchange Outlet 136 can be varied. In the embodiment shown in FIG. 1A, each Choke Outlet 114a, 114b is of the same size and is larger than either the Pressure Exchange Outlet 136 or the Manifold Aperture 122. In certain alternative embodiments, each orifice in the Top Surface 104 of the Body 104 may be the same or varying relative sizes.

In the embodiment shown in FIG. 1A, the Body 102 is generally cylindrical and the Top Surface 104 has a circular cross-section. However, in alternative embodiments, the Body 102 could have a circular cross-section but otherwise be non-cylindrical (such as a conical shape or a cylindrical wedge shape). In the embodiment shown in FIG. 1A, each Choke 110a, 110b, Pressure Exchange 130 and Air Manifold 120 are shown as being generally perpendicular to one another. In alternative embodiments, however, each Choke 110a, 110b, Pressure Exchange 130 and Air Manifold 120 could be skew to one another.

FIG. 1B depicts an enlarged detail of a front, perspective view of one embodiment of a Venturi Aerator having a Body 102, two Chokes 110a, 110b and a Pressure Exchange Tube 132. The embodiment shown in FIG. 1B is an enlarged detail of the embodiment shown in FIG. 1A and is reproduced herein to show any detail obscured by the various reference arrows from FIG. 1A.

FIG. 1C depicts a rear, perspective view of one embodiment of a Venturi Aerator 100 having a Body 102, two Chokes 110a and 110b and a Pressure Exchange Tube 132. In the embodiment shown in FIG. 1C, the Body 102 has a generally cylindrical shape dimensionally sized to fit inside a bottle. In certain embodiments, the Body frictionally engages inside the neck of a wine or liquor bottle (not shown in FIG. 1C). In the embodiment shown in FIG. 1C, the Body 102 of the Venturi Aerator 100 has a Top Surface 104 (not shown in FIG. 1C) and a distal Bottom Surface 106. At least one Choke 110a, 110b extends through the Body 102, with the Choke 110a, 110b having a Choke Outlet 114a, 1114b (not shown in FIG. 1C) at the Top Surface 104 (not shown in FIG. 1C) and a Choke Inlet 112a, 112b at the Bottom Surface 106. In the embodiment shown in FIG. 1C, the Venturi Aerator 100 has two Chokes 110a, 110b. As noted above, however, embodiments having only one Choke or a plurality of Chokes are possible. In the embodiment shown in FIG. 1C, the Venturi Aerator 100 also has at least one Pressure Exchange 130 with at least one Pressure Exchange Outlet 136 (not shown in FIG. 1C) at the Top Surface 104 (not shown in FIG. 1C) of the Body 102. This Pressure Exchange 130 is in fluid communication with a Pressure Exchange Tube 132 which extends outwards from the Bottom Surface 106 of the Body 102. The Pressure Exchange Tube 132 has a Pressure Exchange Inlet 134 distal from the Bottom Surface 106. In the embodiment shown in FIG. 1C, the Venturi Aerator 100 also has an Air Manifold 120 (not shown in FIG. 1C) with a Manifold Aperture 122 (not shown in FIG. 1C) at the Top Surface 104 (not shown in FIG. 1C).

FIG. 1D depicts a cutaway, rear, perspective view of one embodiment of a Venturi Aerator 100 having a Body 102, two Chokes 110a and 110b and a Pressure Exchange Tube 132. In the embodiment shown in FIG. 1D, the Body 102 has a generally cylindrical shape dimensionally sized to fit inside a bottle. In certain embodiments, the Body 102 frictionally engages inside the neck of a wine or liquor bottle (not shown in FIG. 1D). Each Choke 110a and 110b is connected to the Air Manifold 120 by a Manifold Channel 124.

FIG. 1E depicts an enlarged detail of a cutaway, rear, perspective view of one embodiment of a Venturi Aerator 100 having a Body 102, two Chokes 110a, 110b and a Pressure Exchange Tube 132. FIG. 1E depicts the same embodiment of the Venturi Aerator shown in FIG. 1D. In the embodiment shown in FIG. 1E, it can be more clearly seen that the Manifold Channel 124 has a First Channel Opening 126a, 126b and a distal Second Channel Opening 128a, 128b. The First Channel Opening 126a, 126b allows the passage of air from the Air Manifold 120 into the Manifold Channel 124 while the Second Channel Opening 128a, 128b allows the passage of air from the Manifold Channel 120 into a Choke 110a, 110b. Put another way, each Choke 110a, 110b is in fluid communication with the Air Manifold 120 via a Manifold Channel 124. Thus, air is able to flow through the Manifold Aperture 122, down the Air Manifold 120, through the First Channel Opening 126a, 126b, into the Manifold Channel 124 and out of the Second Channel Opening 128a, 128b and into a Choke 110a, 110b. In the embodiment shown in FIG. 1E, each choke 110a, 110b has a Constricted Section 116a, 116b, i.e., an interior part of the choke which narrows. When a fluid (such as wine or alcohol) passes through a Choke 110a, 110b, a Venturi effect occurs at the Constricted Section 116a, 116b. This creates a lower fluid pressure at the Constricted Section 116a, 116b which causes air to be drawn from the Air Manifold 120 through the Manifold Channel 124 and out into the Choke 110a, 110b through the Second Channel Opening 128a, 128b. The resulting air/fluid mixture is more aerated. For example, when Wine flows through a Choke 110a, 110b of a Venturi Aerator 100, the Wine is aerated at the Constricted Section 116a, 116b. When wine passes through the Choke Inlet 112a, 112b and into the Choke 110a, 110b, the Wine is aerated at the Constricted Section 116a, 116b where it draws air from the Manifold Channel 124 out of the Second Channel Opening 128a, 128b and into the Choke 110a, 110b. The resulting Wine/air mixture then flows through the Choke 110a, 110b and exits the Body 102 from a Choke Outlet 114a, 114b.

FIG. 1F depicts a cutaway, side view of one embodiment of a Venturi Aerator having a Body 102, two Chokes 110a, 110b and a Pressure Exchange Tube 132. In the embodiment shown in FIG. 1C, the Body 102 has a generally cylindrical shape dimensionally sized to fit inside a bottle. In certain embodiments, the Body 102 frictionally engages inside the neck of a wine or liquor bottle (not shown in FIG. 1C).

FIG. 1G depicts a cutaway, front, perspective view of one embodiment of a Venturi Aerator 100 having a Body, two Chokes and a Pressure Exchange Tube. The embodiment depicted in FIG. 1G more clearly shows the Pressure Exchange 130 and the Pressure Exchange Outlet 136.

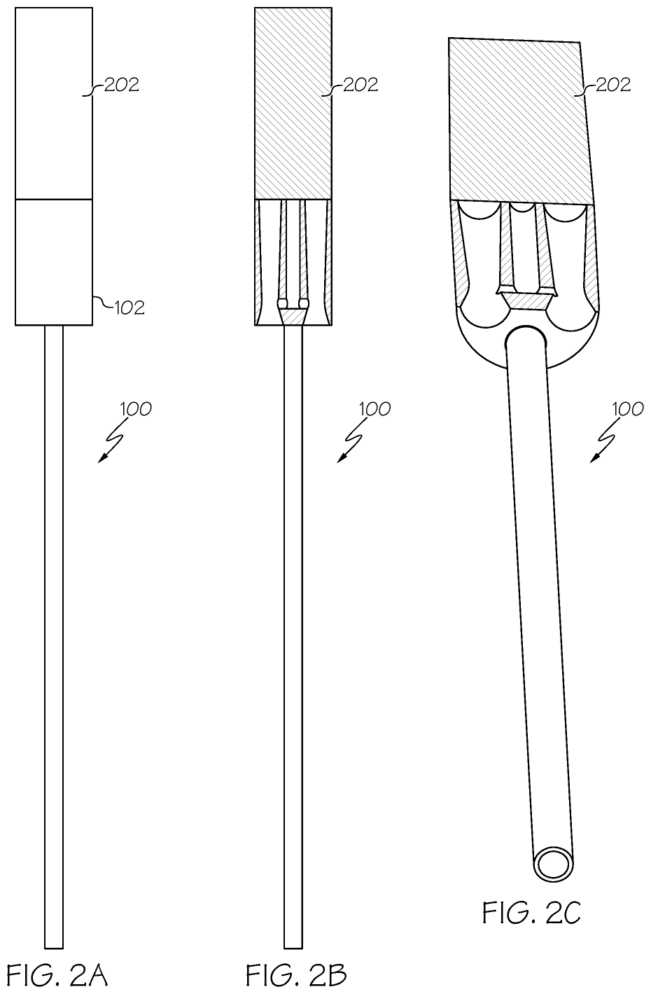

FIG. 2A depicts a side view of one embodiment of a Closure 202 and a Venturi Aerator 100. In certain embodiments the Closure 202 could be a Cork or an Alternative Wine Closure (i.e., a synthetic Cork). In the embodiment shown in FIG. 2A, the Body 102 has a generally cylindrical shape dimensionally sized to fit inside a bottle. In certain embodiments, the Body 102 frictionally engages inside the neck of a wine or liquor bottle (not shown in FIG. 1C). As shown in FIG. 2A, certain embodiments of the Venturi Aerator 100 can be sized to approximate the diameter of a standard Closure 202 such as a Cork or a Synthetic Cork. This allows the Closure 202 to be seated directly atop the Venturi Aerator 100. In other words, the Closure 202 abuts the Top Surface 104 of the Body 102.

FIG. 2B depicts a cutaway, side view of one embodiment of a Closure 202 and a Venturi Aerator 100. In certain embodiments the Closure 202 could be a Cork or an Alternative Wine Closure (i.e., a synthetic Cork).

FIG. 2C depicts a cutaway, rear, perspective view of one embodiment of a Closure 202 and a Venturi Aerator 100. In certain embodiments the Closure 202 could be a Cork or an Alternative Wine Closure (i.e., a synthetic Cork).

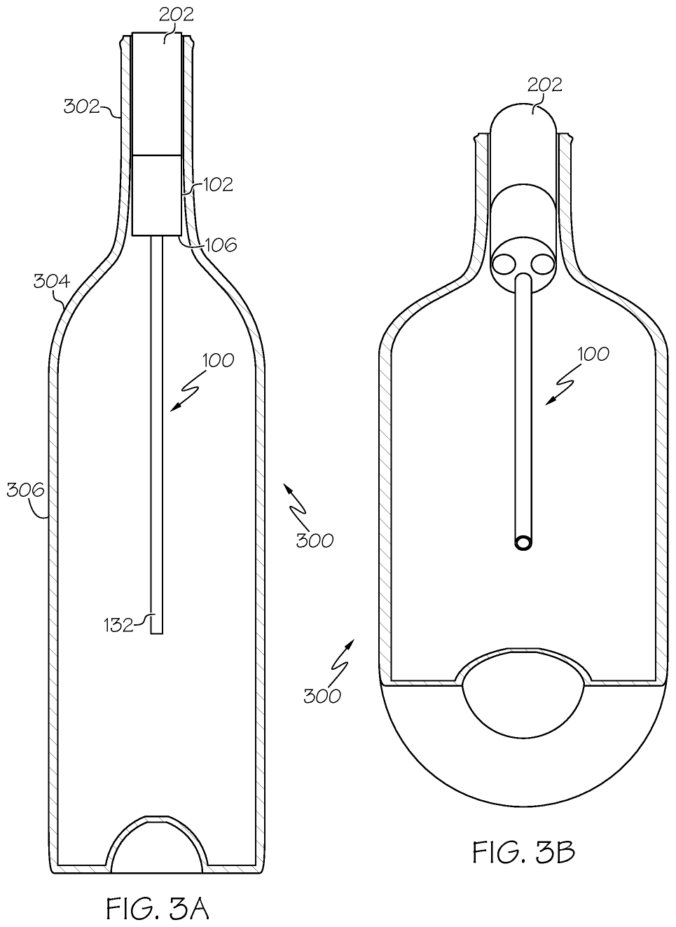

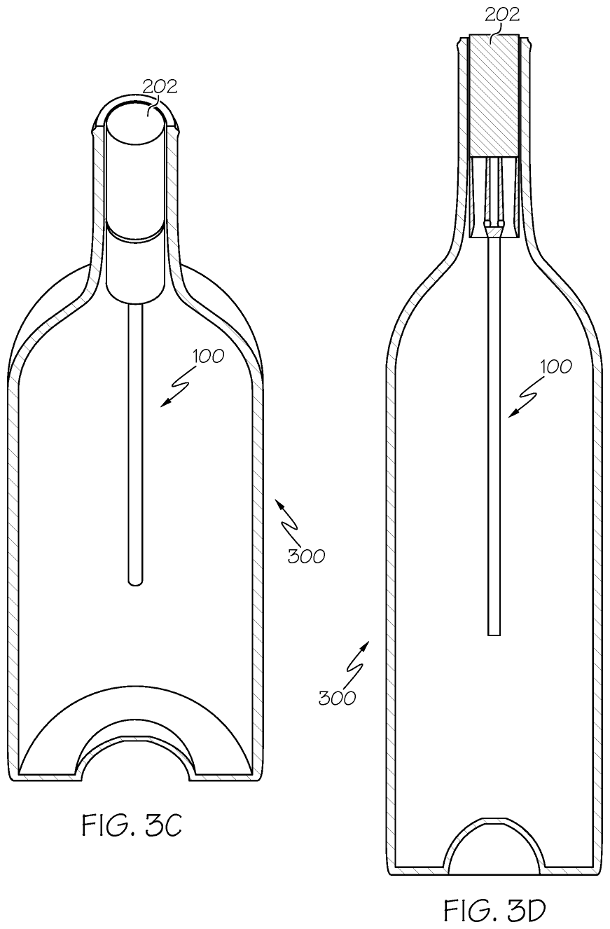

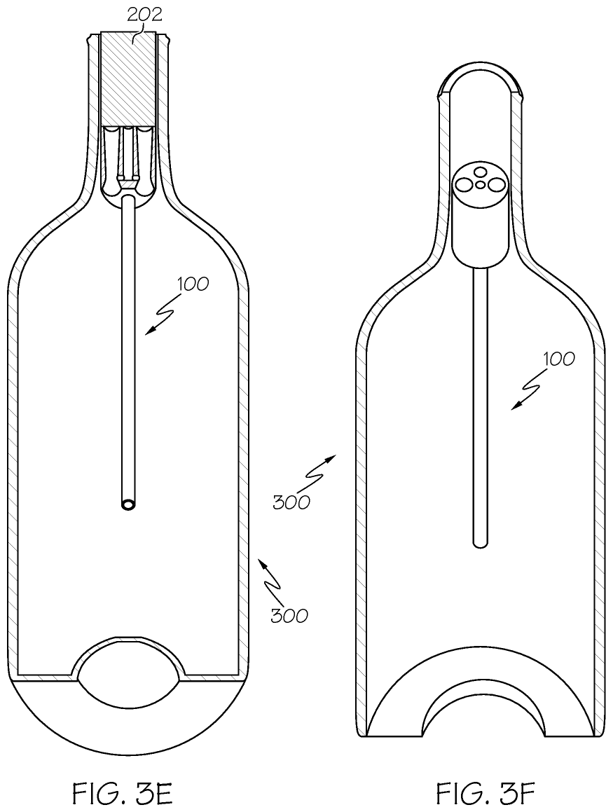

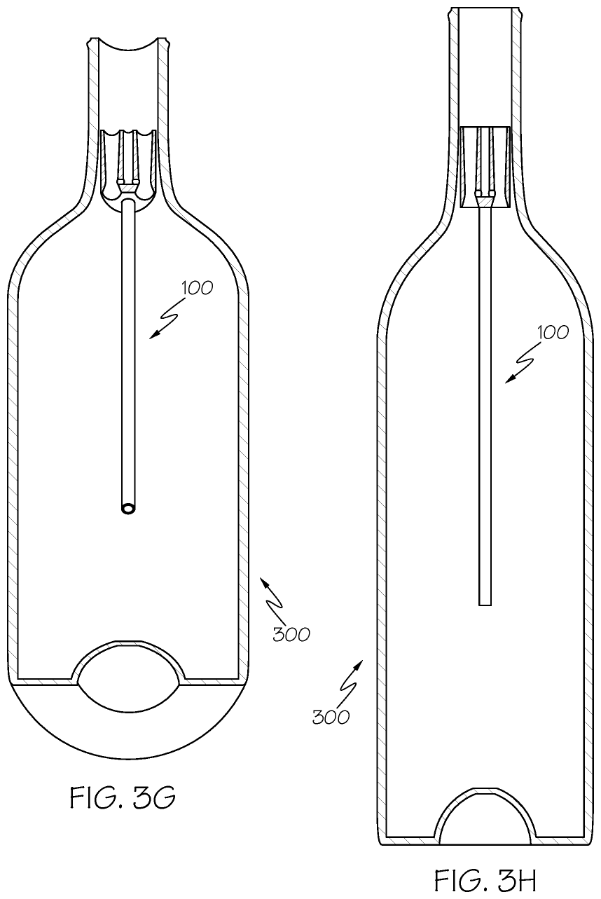

FIG. 3A depicts a side, cutaway view of a Bottle 300 with a side (non-cutaway) view of one embodiment of a Closure 202 and a Venturi Aerator 100. In certain embodiments the Closure 202 could be a Cork or an Alternative Wine Closure (i.e., a synthetic Cork). In the embodiment shown in FIG. 3A, the Bottle 300 is a wine bottle and the Closure 202 is a Cork or a Synthetic Cork. Both the Closure 202 and the Body 102 of the Venturi Aerator 100 are frictionally engaged within the Neck 302 above the Shoulder 304. The Pressure Exchange Tube 132 extends from the Bottom Surface 106 of the Body 102 into the Bottle Body 306. The configuration shown in FIG. 3A, i.e., the seating of the Closure 202 above the Body 102 of the Venturi Aerator 100 allows the bottle 300 to be traditionally opened, i.e., with a corkscrew. Thus, a user could open and remove the Closure 202 in a traditional manner, leaving the Venturi Aerator 100 frictionally engaged within the Neck 302.

FIG. 3B depicts a cutaway, bottom, perspective view of a Bottle 300 with a bottom, perspective (non-cutaway) view of one embodiment of a Closure 202 and a Venturi Aerator 100. In certain embodiments the Closure 202 could be a Cork or an Alternative Wine Closure (i.e., a synthetic Cork).

FIG. 3C depicts a cutaway, top, perspective view of a Bottle 300 with a top, perspective (non-cutaway) view of one embodiment of a Closure 202 and a Venturi Aerator 100. In certain embodiments the Closure 202 could be a Cork or an Alternative Wine Closure (i.e., a synthetic Cork).

FIG. 3D depicts a depicts a cutaway, side view of a Bottle 300 with one embodiment of a Closure 202 and a Venturi Aerator 100. In certain embodiments the Closure 202 could be a Cork or an Alternative Wine Closure (i.e., a synthetic Cork).

FIG. 3E depicts a cutaway, bottom, perspective view of a Bottle 300 with one embodiment of a Closure 202 and a Venturi Aerator 100. In certain embodiments the Closure 202 could be a Cork or an Alternative Wine Closure (i.e., a synthetic Cork).

FIG. 3F depicts a cutaway, top, perspective view of a Bottle 300 (with no Closure) with a top, perspective (non-cutaway) view of one embodiment of a Venturi Aerator 100.

FIG. 3G depicts a cutaway, bottom, perspective view of a Bottle 300 (with no Closure) with one embodiment of a Venturi Aerator 100.

FIG. 3H depicts a cutaway, side view of a Bottle 300 (with no Closure) with one embodiment of a Venturi Aerator 100.

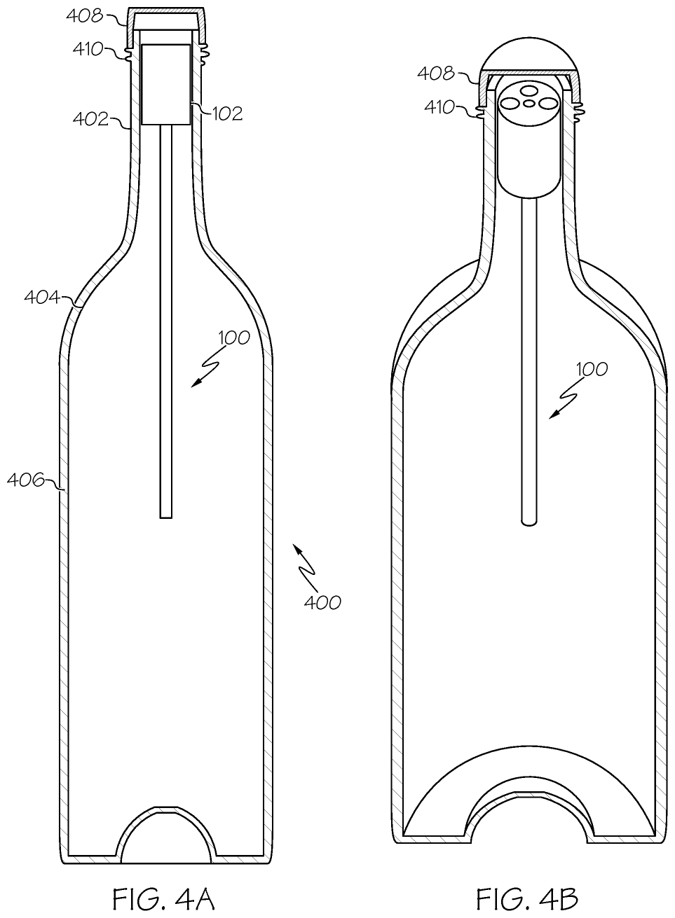

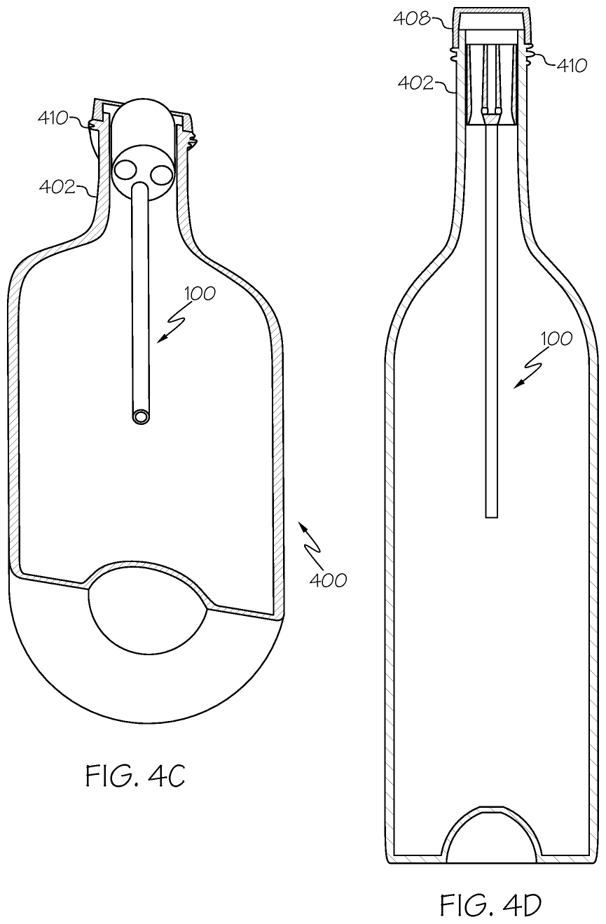

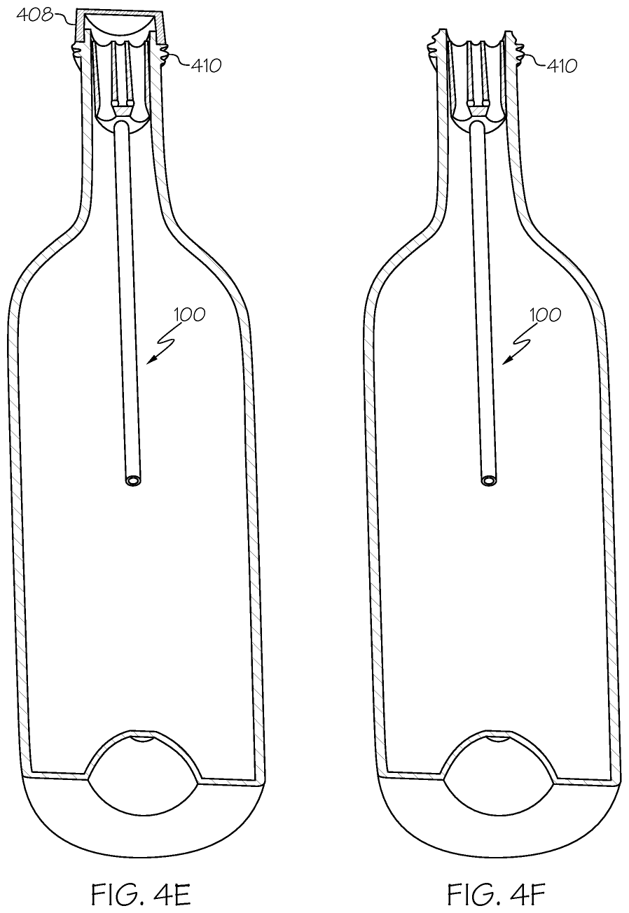

FIG. 4A depicts a cutaway, side view of a Screw Cap Bottle 400 with a side (non-cutaway) view of one embodiment of a Venturi Aerator 100. The Bottle 400 has a Neck 402, a Shoulder 404 and a Body 406. In the embodiment shown in FIG. 4A, the Bottle 400 has a Screw Cap 408 which is threaded onto External Threading 410 formed in the Bottle 400. In the embodiment shown in FIG. 4A, the Body 102 of the Venturi Aerator 100 has a generally cylindrical shape dimensionally sized to fit inside the Bottle 400. In the embodiment shown in FIG. 4A, the Venturi Aerator 100 may be located higher in the Neck 402 of the Bottle 400 than in embodiments in which a Closure (e.g., Closure 202) is used (in which embodiments the Venturi Aerator 100 is generally located in the Neck 402 but closer to the Shoulder 404 of the Bottle 400).

FIG. 4B depicts a cutaway, top, perspective view of a Screw Cap Bottle 400 having a Screw Cap 408 which is threaded onto External Threading 410 with a top, perspective (non-cutaway) view of one embodiment of a Venturi Aerator 100.

FIG. 4C depicts a cutaway, bottom, perspective view of a Screw Cap Bottle 400 having External Threading 410 on the Neck 402 with a bottom, perspective (non-cutaway) view of one embodiment of a Venturi Aerator 100.

FIG. 4D depicts a cutaway, side view of a Screw Cap Bottle 400 having a Screw Cap 408 which is threaded onto External Threading 410 on the Neck 402 with one embodiment of a Venturi Aerator 100.

FIG. 4E depicts a cutaway, bottom, perspective view of a Screw Cap Bottle 400 having a Screw Cap 408 which is threaded onto External Threading 410 with one embodiment of a Venturi Aerator 100.

FIG. 4F depicts a cutaway, bottom, perspective, view of a Screw Cap Bottle 400 (with no Screw Cap) having External Threading 410 and with one embodiment of a Venturi Aerator 100. In the embodiment shown in FIG. 4F, the Screw Cap 408 has been removed from the Bottle 400.

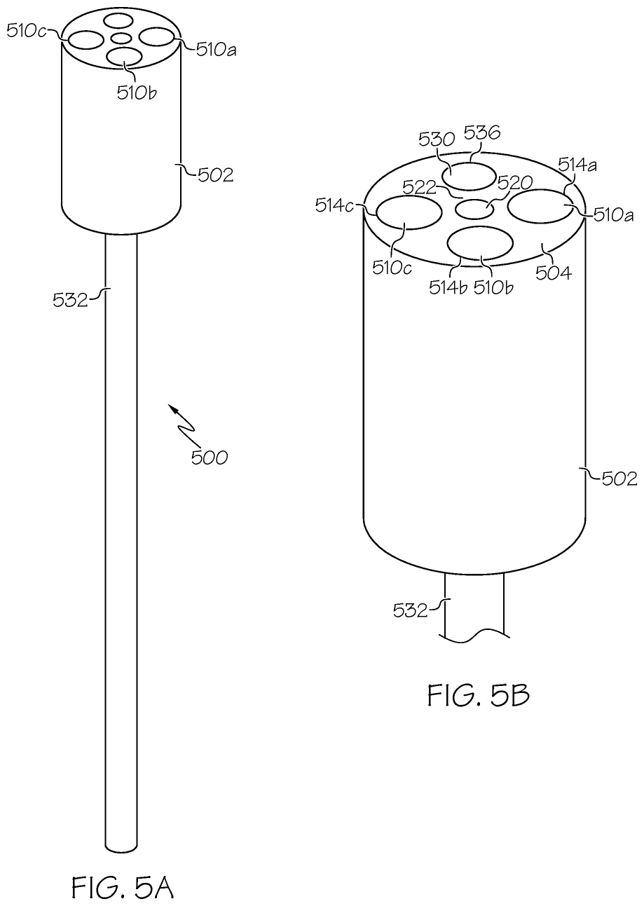

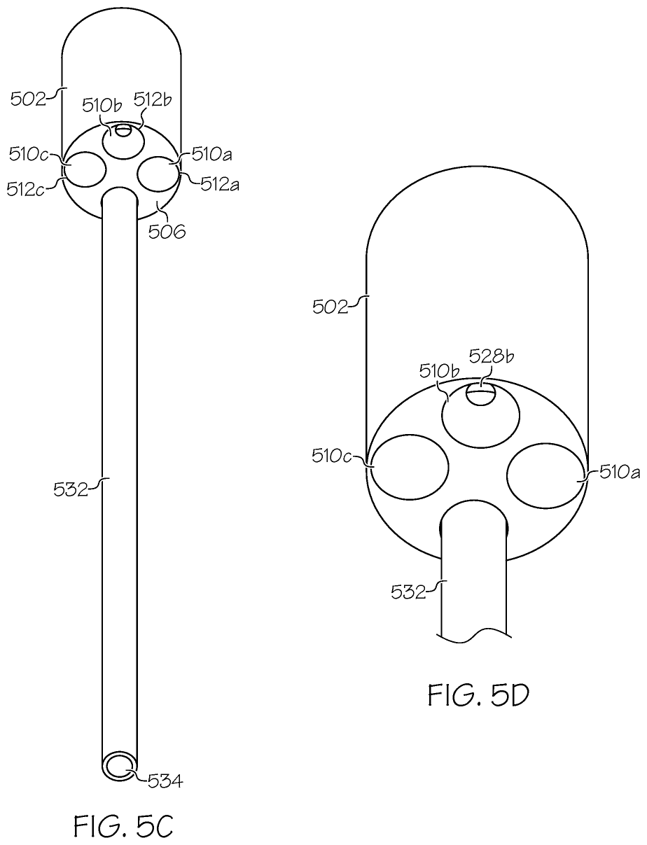

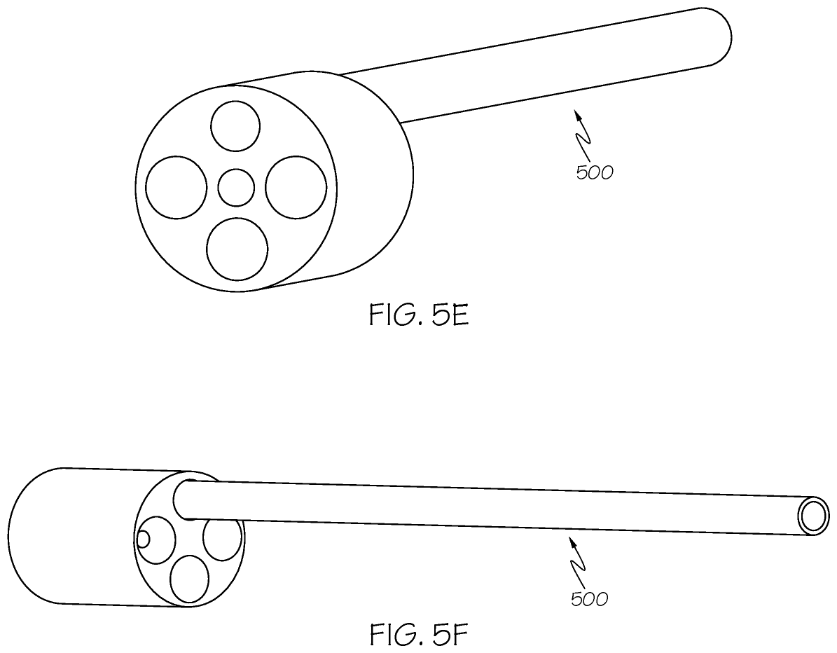

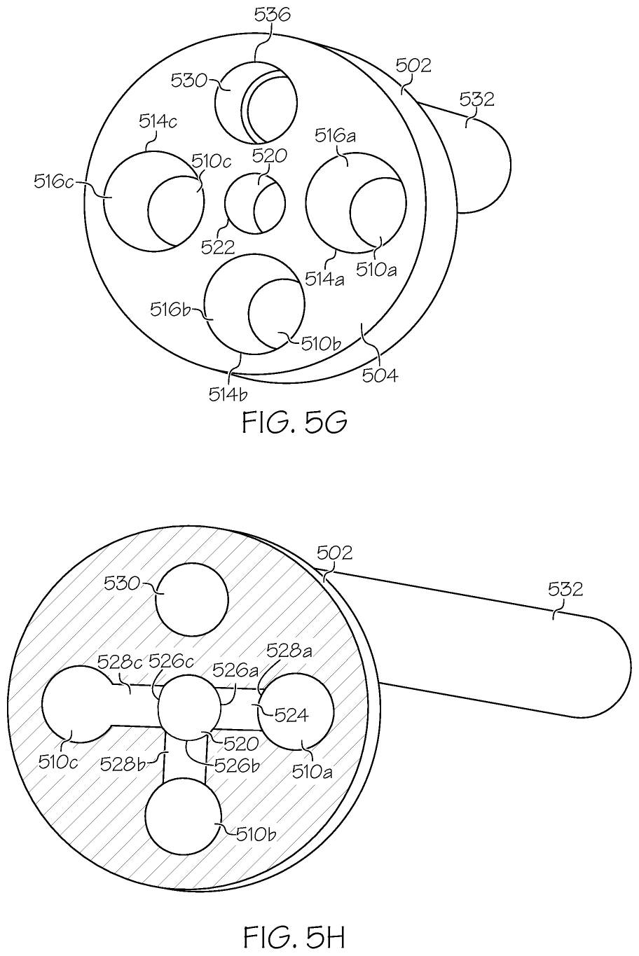

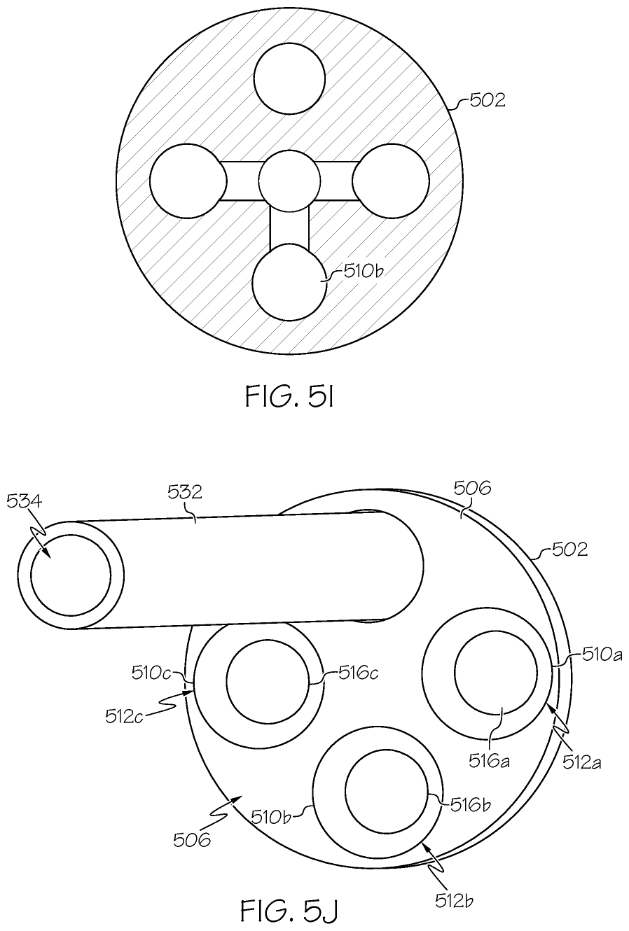

FIG. 5A depicts a front, perspective view of one embodiment of a Venturi Aerator 500 having a Body, three Chokes 510a, 510b, 510c and a Pressure Exchange Tube 532.

FIG. 5B depicts an enlarged detail of a front, perspective view of one embodiment of a Venturi Aerator 500 having a Body 502, three Chokes 510a, 510b, 510c and a Pressure Exchange Tube 532.

FIG. 5C depicts a rear, perspective view of one embodiment of a Venturi Aerator 500 having a Body 502, three Chokes 510a, 510b, 510c and a Pressure Exchange Tube 532.

FIG. 5D depicts an enlarged detail of a rear, perspective view of one embodiment of a Venturi Aerator having a Body 502, three Chokes 510a, 510b, 510c and a Pressure Exchange Tube 532. As can be seen in FIG. 5D, one Second Channel Opening 528b is visible when the Choke 510b is viewed at an angle.

FIG. 5E depicts a perspective view of one embodiment of a Venturi Aerator 500 having a Body, three Chokes and a Pressure Exchange Tube.

FIG. 5F depicts a perspective view of one embodiment of a Venturi Aerator 500 having a Body, three Chokes and a Pressure Exchange Tube.

FIG. 5G depicts a perspective view of one embodiment of a Venturi Aerator 500 having a Body 502, three Chokes 510a, 510b, 510c and a Pressure Exchange Tube 532. In the embodiment shown in FIG. 5G, the Venturi Aerator 500 has a Top Surface 504 and a Distal Bottom Surface 506 (not shown in FIG. 5G). In the embodiment shown in FIG. 5G, the Body 502 has a generally cylindrical shape dimensionally sized to fit inside a bottle. In certain embodiments, the Body 502 frictionally engages inside the neck of a wine or liquor bottle (not shown in FIG. 5G). In certain embodiments, the Body 502 is dimensionally sized to match a Number 7, 8, 9 or 10 size cork. The Body 502 may be constructed of any food grade material. In certain embodiments, the Body 502 is made out of food grade plastics or food grade synthetic cork material such as low-density polyethylene (“LDPE”). In the embodiment shown in FIG. 5G, the Body 502 has a Top Surface 504 and a distal Bottom Surface 506 (not shown in FIG. 5G). At least one Choke 510a, 510b, 510c extends through the Body 502, with the Choke 510a, 510b, 510c, having a Choke Outlet 514a, 514b, 514c at the Top Surface 504 and a Choke Inlet 512a, 512b, 512c (not shown in FIG. 5G) at the Bottom Surface 506 (not shown in FIG. 5G). In the embodiment shown in FIG. 5G, the Venturi Aerator 500 has three Chokes 510a, 510b, and 510c. As noted above, however, embodiments having only one Choke or a plurality of Chokes are possible. In the embodiment shown in FIG. 5G, the Venturi Aerator 500 also has at least one Pressure Exchange 530 with at least one Pressure Exchange Outlet 536 at the Top Surface 504 of the Body 502. This Pressure Exchange 530 is in fluid communication with a Pressure Exchange Tube 532 which extends outwards from the Bottom Surface 506 (not shown in FIG. 1A) of the Body 502. The purpose of the Pressure Exchange 530 is to equalize the pressure inside the bottle with the outside air pressure. This allows for a smooth flow of liquid as air bubbles into the bottle through the Pressure Exchange Tube 532 as liquid pours out of the Bottle. In certain embodiments, the Pressure Exchange Tube 532 extends into the body-portion of a bottle. In certain embodiments, the Pressure Exchange Tube 532 extends approximately one inch beyond the Body 502 of the Venturi Aerator 500. In certain embodiments, the Body 502 of the Venturi Aerator 500 is approximately 3¼ inches in length. The Pressure Exchange Tube 532 may be formed of any food-grade material. In the preferred embodiment, the Pressure Exchange Tube 532 is made of a plastic so that it is shatter-resistant. In the embodiment shown in FIG. 5G, the Venturi Aerator 500 also has an Air Manifold 520 with a Manifold Aperture 522 at the Top Surface 504. In the embodiment shown in FIG. 5G, the Air Manifold 520 is shown as centrally located in the Body 502. In other embodiments, however, the Air Manifold 520 may be offset from the center, i.e., it may be in another position in the Body 502. In some embodiments, the Pressure Exchange Tube 532 may be integrally formed with the body 502 to form the Venturi Aerator 500. However, in certain embodiments, the Pressure Exchange Tube 532 may be separately manufactured then attached to the Body 502 to form the Venturi Aerator 500. For example, the Pressure Exchange Tube 532 can be press fit into the Body 502, sonically welded to the Body 502, or attached to the Body 502 with an adhesive. In the embodiment shown in FIG. 5G, the three Chokes 510a, 510b, 510c and the Pressure Exchange Outlet 536 are equidistantly distributed radially around the Manifold Aperture 522. In other embodiments, however, each Choke and the Pressure Exchange Outlet could be located in other configurations. Each choke 510a, 510b, 510c has a Constricted Section 516a, 516b, 516c, i.e., an interior part of the choke which narrows. When a fluid (such as wine or alcohol) passes through a Choke 510a, 510b, 510c, a Venturi effect occurs at the Constricted Section 516a, 516b, 516c. In the embodiment shown in FIG. 5G, the Venturi Aerator 500 also has an Air Manifold 520 with a Manifold Aperture 522 at the Top Surface 504. In the embodiment shown in FIG. 5G, the Air Manifold 520 is shown as centrally located in the Body 502. In other embodiments, however, the Air Manifold 520 may be offset from the center, i.e., it may be in another position in the Body 502. The relative size of each Choke Outlet 514a, 514b, 514c, Manifold Aperture 522 and Pressure Exchange Outlet 536 can be varied. In the embodiment shown in FIG. 5G, each Choke Outlet 514a, 514b, 514c is of the same size and is larger than either the Pressure Exchange Outlet 536 or the Manifold Aperture 520. In certain alternative embodiments, each orifice in the Top Surface 504 of the Body 502 may be the same or varying relative sizes.

FIG. 5H depicts a cutaway, perspective view of one embodiment of a Venturi Aerator 500 having a Body 502, three Chokes 510a, 510c, 510c and a Pressure Exchange Tube 532. The embodiment shown in FIG. 5H is a cross sectional view of the embodiment shown in FIG. 5G taken approximately halfway through the thickness of the Body 502. As can be seen in the embodiment shown in FIG. 5G, the Air Manifold 520 is connected to at least one Manifold Channel 524. Each Manifold Channel 524 has a First Channel Opening 526a, 526b, 526c and a distal Second Channel Opening 528a, 528b, 528c. The First Channel Opening 526a, 526b, 526c allows the passage of air from the Air Manifold 520 into the Manifold Channel 524 while the Second Channel Opening 528a, 528b, 528c allows the passage of air from the Manifold Channel 524 into a Choke 510a, 510b, 510c. Put another way, each Choke 510a, 510b, 510c is in fluid communication with the Air Manifold 520 via a Manifold Channel 524. Thus, air is able to flow through the Manifold Aperture 522, down the Air Manifold 520, through the First Channel Opening 526a, 526b, 526c, into the Manifold Channel 524 and out of the Second Channel Opening 528a, 528b, 528c and into a Choke 510a, 510b, 510c. Each Choke 510a, 510b, 510c has a Constricted Section 516a, 516b, 516c, i.e., an interior part of the choke which narrows. When a fluid (such as wine or alcohol) passes through a Choke 510a, 510b, 510c, a Venturi effect occurs at the Constricted Section 516a, 516b, 516c. This creates a lower fluid pressure at the Constricted Section 516a, 516b, 516c which causes air to be drawn from the Air Manifold 520 through the Manifold Channel 524 and out into the Choke 510a, 510b, 510c through the Second Channel Opening 528a, 528b, 528c. The resulting air/fluid mixture is more aerated. For example, when Wine flows through a Choke 510a, 510b, 510c of a Venturi Aerator 500, the Wine is aerated at the Constricted Section 516a, 516b, 516c. When wine passes through the Choke Inlet 512a, 512b, 512c, and into the Choke 510a, 510b, 510c, the Wine is aerated at the Constricted Section 516a, 516b, 516c where it draws air from the Manifold Channel 524 out of the Second Channel Opening 528a, 528b, 528c and into the Choke 510a, 510b, 510c. The resulting Wine/air mixture then flows through the Choke 510a, 510b, 510c and exits the Body 502 from a Choke Outlet 514a, 514b, 514c.

FIG. 5I depicts a cutaway, front view of one embodiment of a Venturi Aerator 500 having a Body 502, three Chokes 510a, 510b, 510c and a Pressure Exchange Tube (not shown).

FIG. 5J depicts a rear, perspective view of one embodiment of a Venturi Aerator 500 having a Body 502, three Chokes 510a, 510b, 510c and a Pressure Exchange Tube 532. The Pressure Exchange Tube 532 has a Pressure Exchange Inlet 534 distal from the Bottom Surface 506.

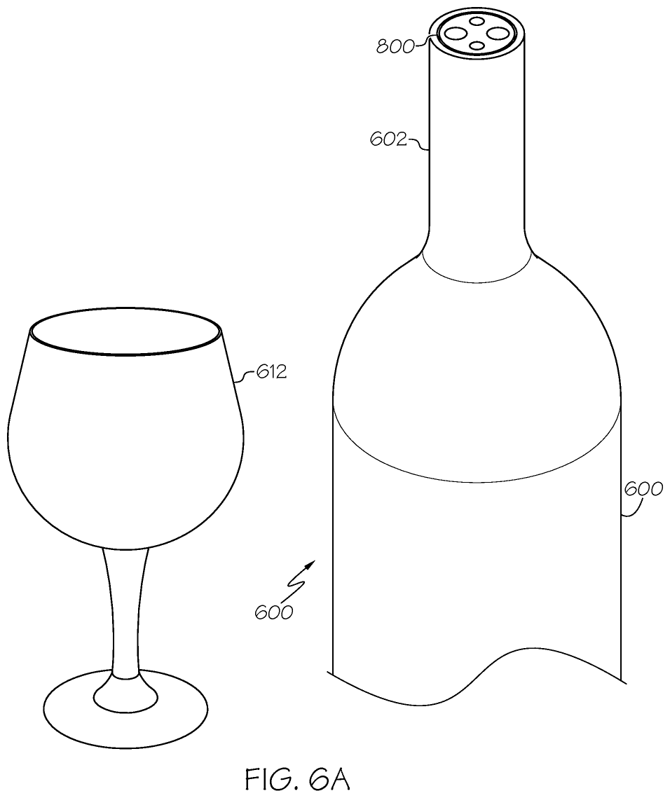

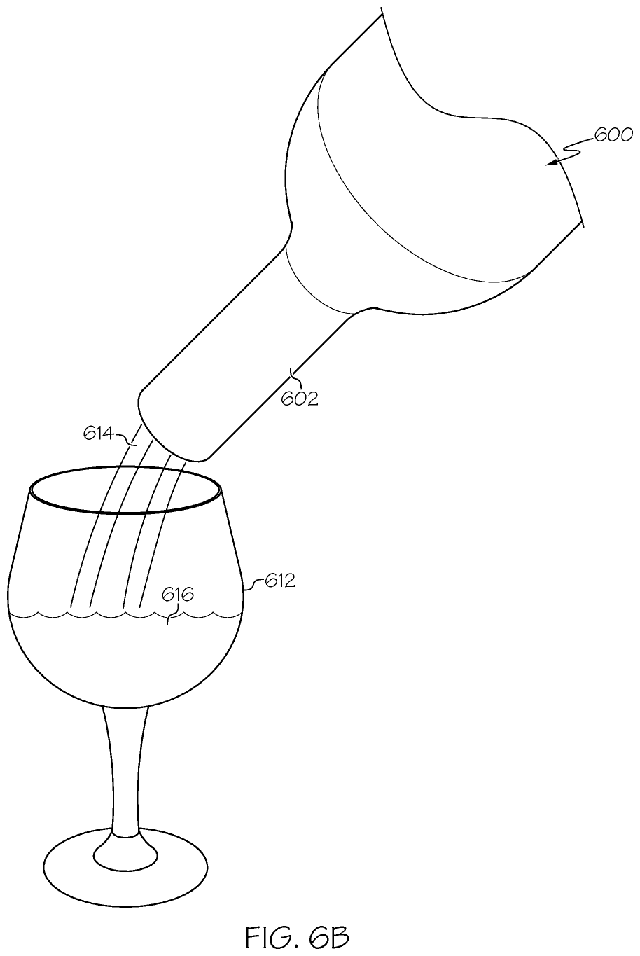

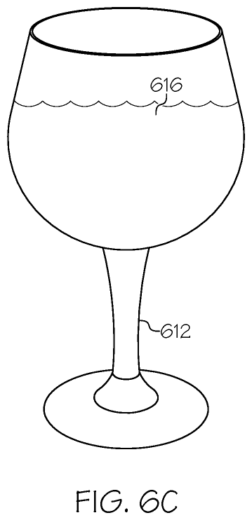

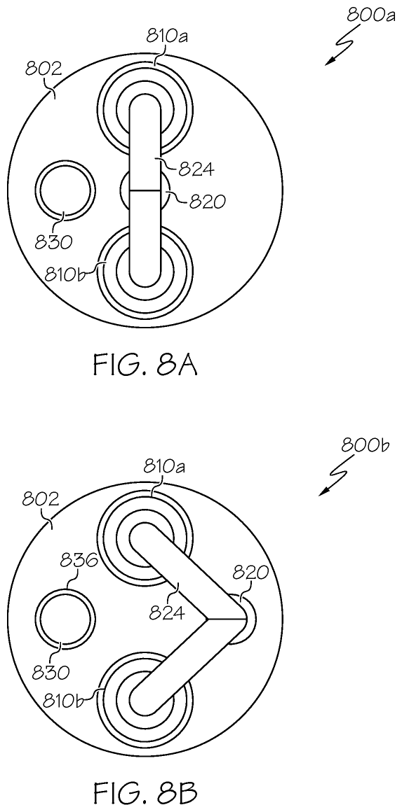

FIG. 6A depicts a perspective view of an embodiment of a Venturi Aerator 800 having a body 802, two Chokes 810a, 810b and a Pressure Exchange Tube (see FIG. 8B) inserted into a Wine Bottle 600. The Wine Bottle 600 is partially filled with Wine and is adjacent to an empty Wine Glass 612. The embodiment shown in FIG. 6A has two Chokes 810a, 810b, a Pressure Exchange Outlet 536 and an Air Manifold 820 (see FIG. 8B). In the embodiment shown in FIG. 6A, the Choke Outlets 810a, 810b, the Manifold Aperture 820 and the Pressure Exchange Outlet 836 are all radially distributed around a central axis of the Venturi Aerator 800. It should be understood that, while not shown in FIG. 6A, the Pressure Exchange Tube also protrudes into a Bottle Body 606 of the Wine Bottle 600.

FIG. 6B depicts a perspective view of a user pouring wine using an embodiment of a Venturi Aerator which has been inserted into a Wine Bottle. This is the same Venturi Aerator 800 and Wine Bottle 600 depicted in FIG. 6A. As can be seen in FIG. 6B, the embodiment of the Venturi Aerator 800 has been inserted into the Neck 602 of the Bottle 600. Because the embodiment of the Venturi Aerator 800 shown in FIG. 6B has two Chokes 810a, 810b, two Aerated Wine Streams 614 can be seen when wine is poured from the bottle 600. This Aerated Wine is then poured into a Glass 612.

FIG. 6C depicts a perspective view of a Wine Glass 612 filled with Wine 616 aerated by an embodiment of a Venturi Aerator 800. The rippled surface of the aerated Wine 616 represents a number of air bubbles inside the Glass 612.

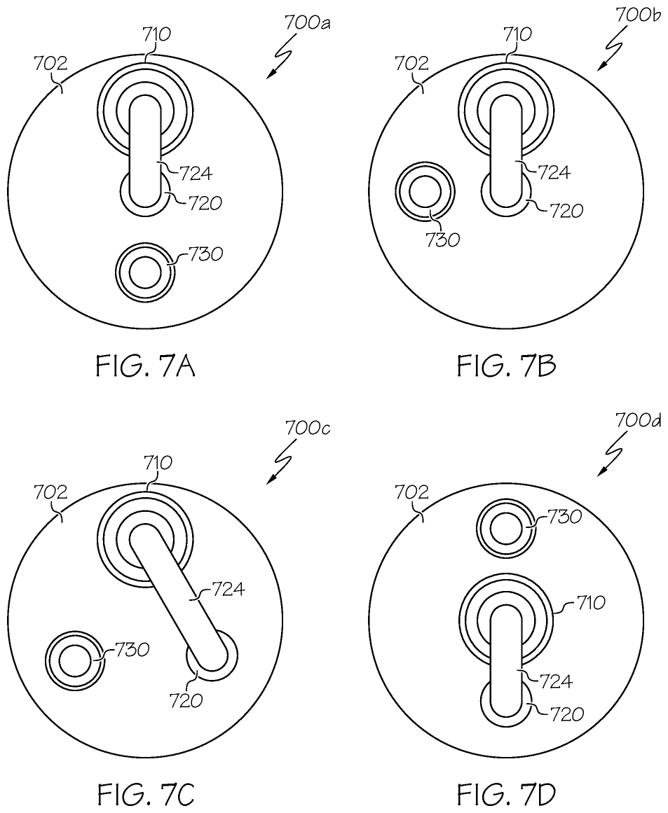

FIG. 7A depicts a diagram showing a potential configuration of an embodiment of a Venturi Aerator 700a having one Choke 710. The embodiment of the Venturi Aerator 700a shown in FIG. 7A has a Body 702 which, in turn, has a single Choke 710 and a Pressure Exchange 730. The Body 702 further has an Air Manifold 720. The Choke 710, Air Manifold 720, and Pressure Exchange 730 are arranged in a linear fashion, with the Air Manifold 720 being centrally located, the Choke 710 being disposed above the Air Manifold 720, and the Pressure Exchange 730 being disposed below the Air Manifold 720. A Manifold Channel 724 is integral to the Body 702 and connects the Choke 710 to the Air Manifold 720. This allows a fluid (such as wine or liquor) to flow through the Choke 710 and become aerated.

FIG. 7B depicts a diagram showing a potential configuration of an embodiment of a Venturi Aerator 700b having one Choke 710. The embodiment of the Venturi Aerator 700b shown in FIG. 7B has a Body 702 which, in turn, has a single Choke 710 and a Pressure Exchange 730. The Body 702 further has an Air Manifold 720. The Choke 710, Pressure Exchange 730, and Air Manifold 720 are arranged in an L-shape, with the Air Manifold 720 being centrally located, the Choke 710 being disposed above the Air Manifold 720, and the Pressure Exchange 730 being disposed approximately 90 degrees from the Choke 710 at the left side of the Air Manifold 720. A Manifold Channel 724 is integral to the Body 702 and connects the Choke 710 to the Air Manifold 720. This allows a fluid (such as wine or liquor) to flow through the Choke 710 and become aerated.

FIG. 7C depicts a diagram showing a potential configuration of an embodiment of a Venturi Aerator 700c having one Choke 710. The embodiment of the Venturi Aerator 700c shown in FIG. 7C has a Body 702 which, in turn, has a single Choke 710 and a Pressure Exchange 730. The Body 702 further has an Air Manifold 720. The Choke 710, Air Manifold 720, and Pressure Exchange 730 are arranged in a triangular-shape. A Manifold Channel 724 is integral to the Body 702 and connects the Choke 710 to the Air Manifold 720. This allows a fluid (such as wine or liquor) to flow through the Choke 710 and become aerated.

FIG. 7D depicts a diagram showing a potential configuration of an embodiment of a Venturi Aerator 700d having one Choke 710. The embodiment of the Venturi Aerator shown in FIG. 7D has a Body 702 which, in turn, has a single Choke 710 and a Pressure Exchange 730. The Body 702 further has an Air Manifold 720. The Choke 710, Air Manifold 720, and Pressure Exchange 730 are arranged in a linear fashion, with the Choke 710 being centrally located, the Pressure Exchange 730 being disposed above the Choke 710, and the Air Manifold 720 being disposed below the Choke 710. A Manifold Channel 724 is integral to the Body 702 and connects the Choke 710 to the Air Manifold 720. This allows a fluid (such as wine or liquor) to flow through the Choke 710 and become aerated.

FIG. 8A depicts a diagram showing a potential configuration of an embodiment of a Venturi Aerator 800a having two Chokes 810a, 810b. The embodiment of the Venturi Aerator 800a shown in FIG. 8A has a Body 802 which, in turn, has two Chokes 810a, 810b and a Pressure Exchange 830. The Body 802 further has an Air Manifold 820. The two Chokes 810a, 810b and the Air Manifold are arranged linearly, with the Air Manifold 820 being centrally disposed between the two Chokes 810a, 810b. The Pressure Exchange 830 is disposed approximately 90 degrees from the two Chokes 810a, 810b at the left side of the Air Manifold 820. Each Manifold Channel 824 is integral to the Body 802 and connects a Choke 810a, 810b to the Air Manifold 820. This allows a fluid (such as wine or liquor) to flow through the Chokes 810a, 810b and become aerated.

FIG. 8B depicts a diagram showing a potential configuration of an embodiment of a Venturi Aerator 800b having two Chokes 810a, 810b. The embodiment of the Venturi Aerator 800b shown in FIG. 8B has a Body 802 which, in turn, has two Chokes 810a, 810b and a Pressure Exchange 830. The Body 802 further has an Air Manifold 820. The two Chokes 810a, 810b, Air Manifold 820, and Pressure Exchange 830 are arranged in a cross-shape, with the two Chokes 810a, 810b spaced apart to form the vertical portion of the cross-shape and the Air Manifold 820 and Pressure Exchange 830 spaced apart to form the horizontal portion of the cross-shape. Each Manifold Channel 824 is integral to the Body 802 and connects a Choke 810a, 810b to the Air Manifold 820. This allows a fluid (such as wine or liquor) to flow through the Chokes 810a, 810b and become aerated.

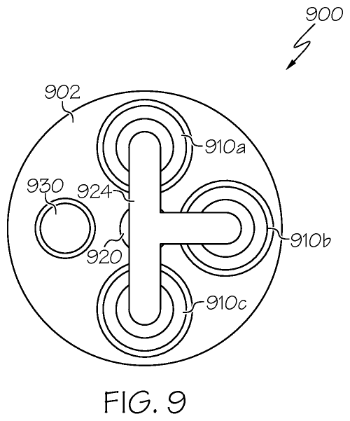

FIG. 9 depicts a diagram showing a potential configuration of an embodiment of a Venturi Aerator 900 having three Chokes 910a, 910b, 910c. The embodiment of the Venturi Aerator 900 shown in FIG. 9 has a Body 902 which, in turn, has three Chokes 910a, 910b, 910c and a Pressure Exchange 930. The Body 902 further has an Air Manifold 920. The three Chokes 910a, 910b, 910c are arranged in a T-shape, with the Air Manifold 820 being centrally disposed Each Manifold Channel 924 is integral to the Body 902 and connects a Choke 910a, 910b, 910c to an Air Manifold 920. This allows a fluid (such as wine or liquor) to flow through the Chokes 910a, 910b, 910c and become aerated.

The purpose of FIGS. 7A through 9 is to illustrate some of the many potential embodiments of the Venturi Aerator, namely, various embodiments comprising different numbers of Chokes and different relative positions of each Choke, Pressure Exchange and Air Manifold.

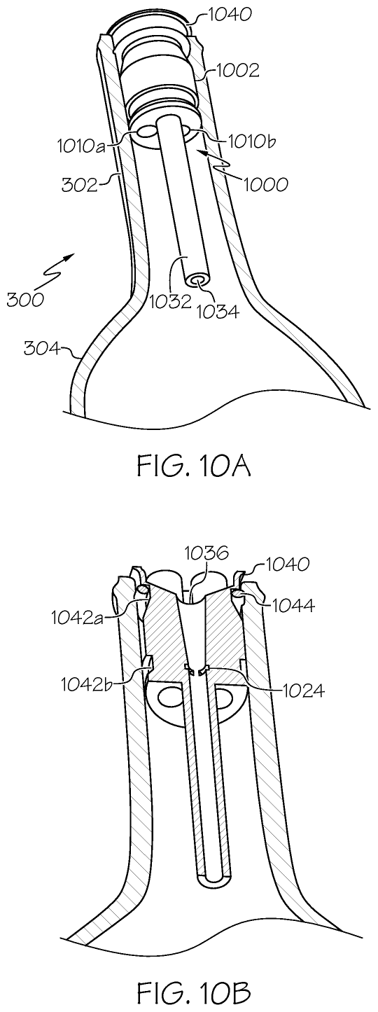

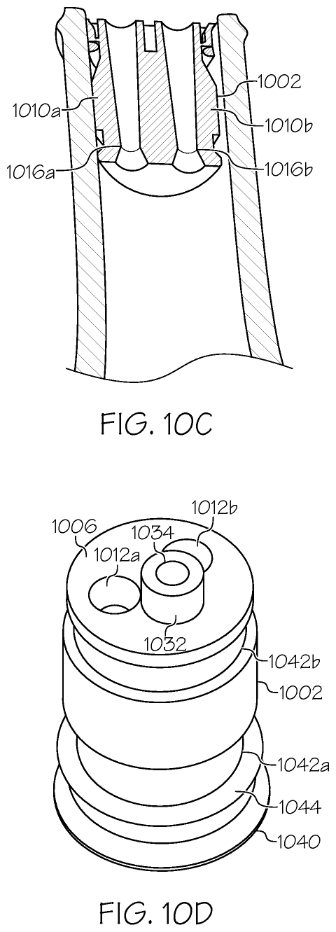

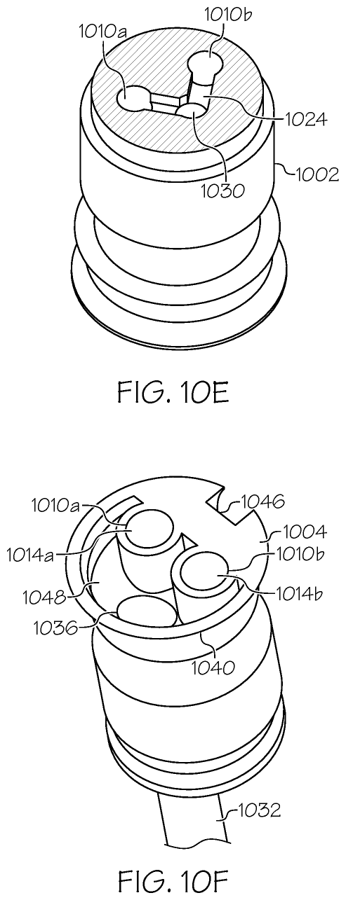

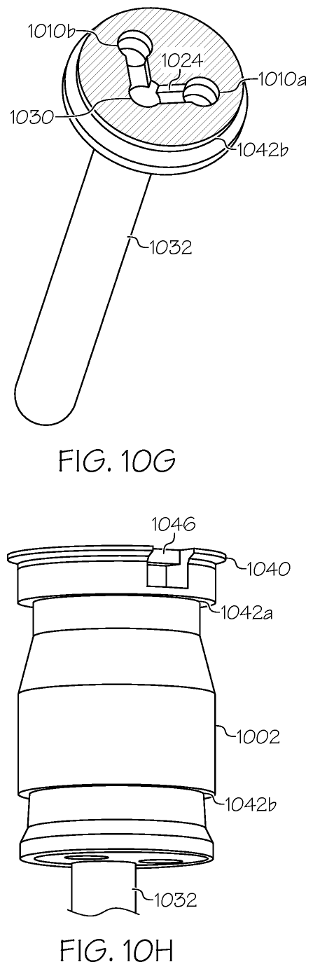

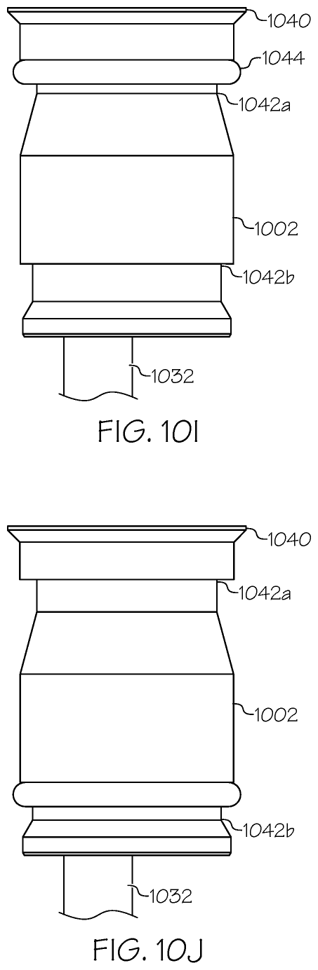

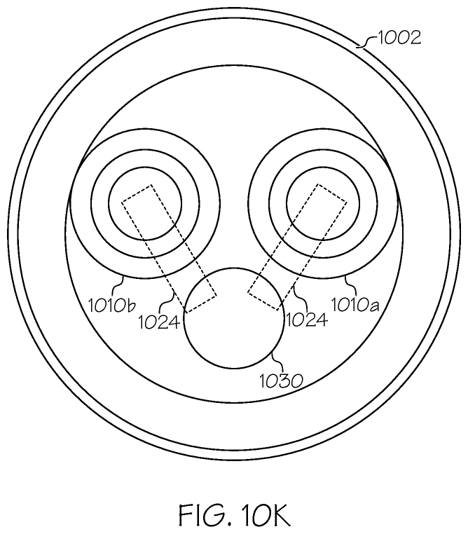

FIGS. 10A-10K depict one embodiment of a Venturi Aerator 1000 having a Body 1002, two Chokes 1010a, 1010b, and a Pressure Exchange Tube 1032. The Venturi Aerator 1000 has a Top Surface 1004 and a Distal Bottom Surface 1006. The Body 1002 has a generally cylindrical shape dimensionally sized to fit inside a bottle 300. In certain embodiments, the Body 1002 frictionally engages inside the neck 302 of a wine or liquor bottle 300. In certain embodiments, the Body 1002 is dimensionally sized to match a Number 7, 8, 9 or 10 size cork. The Body 1002 may be constructed of any food grade material. In certain embodiments, the Body 1002 is made out of food grade plastics or food grade synthetic cork material such as low-density polyethylene (“LDPE”). The Body 1002 has a Top Surface 1004 and a distal Bottom Surface 1006. At least one Choke 1010a, 1010b extends through the Body 1002, with the Choke 1010a, 1010b, having a Choke Outlet 1014a, 1014b at the Top Surface 1004 and a Choke Inlet 1012a, 1012b at the Bottom Surface 1006. The Venturi Aerator 1000 has two Chokes 1010a and 1010b. As noted above, however, embodiments having only one Choke or a plurality of Chokes are possible. Each choke 1010a, 1010b has a Constricted Section 1016a, 1016b, i.e., an interior part of the choke which narrows. When a fluid (such as wine or alcohol) passes through a Choke 1010a, 1010b, a Venturi effect occurs at the Constricted Section 1016a, 1016b.

The Venturi Aerator 1000 in FIGS. 10A-10K also has at least one Pressure Exchange 1030 with at least one Pressure Exchange Outlet 1036 at the Top Surface 1004 of the Body 1002. The Pressure Exchange Tube 1032 also has a Pressure Exchange Inlet 1034 distal from the Bottom Surface 1006. This Pressure Exchange 1030 is in fluid communication with a Pressure Exchange Tube 1032 which extends outwards from the Bottom Surface 1006 of the Body 1002. The purpose of the Pressure Exchange 1030 is to equalize the pressure inside the bottle with the outside air pressure. This allows for a smooth flow of liquid as air bubbles into the bottle through the Pressure Exchange Tube 1032 as liquid pours out of the Bottle 300. In certain embodiments, the Pressure Exchange Tube 1032 extends into the body-portion of a bottle 300, and more particularly, extends along the length of the neck 302 of the bottle 300 and stops at the beginning of the shoulder 304 of the bottle 300. In certain embodiments, the Pressure Exchange Tube 1032 extends approximately one inch beyond the Body 1002 of the Venturi Aerator 1000. In certain embodiments, the Body 1002 of the Venturi Aerator 1000 is approximately 3¼ inches in length. The Pressure Exchange Tube 1032 may be formed of any food-grade material. In the preferred embodiment, the Pressure Exchange Tube 1032 is made of a plastic so that it is shatter-resistant.

In the embodiment shown in FIGS. 10A-10K, the two Chokes 1010a, 1010b and the Pressure Exchange Outlet 1036 are generally distributed radially around a central longitudinal axis of the Body 1002. In other embodiments, however, each Choke and the Pressure Exchange Outlet could be located in other configurations. The relative size of each Choke Outlet 1014a, 1014b and Pressure Exchange Outlet 1036 can be varied. In the embodiment shown in FIGS. 10A-10K, each Choke Outlet 1014a, 1014b is of the same size and is generally smaller than the Pressure Exchange Outlet 1036. In certain alternative embodiments, each orifice in the Top Surface 1004 of the Body 1002 may be the same or varying relative sizes.

In the embodiments shown in FIG. 10A-10K, the Venturi Aerator 1000, different from previous embodiments described above, does not include a separate Air Manifold. Rather, the Pressure Exchange 1030 is configured to act as the Air Manifold for the Venturi Aerator 1000. The Pressure Exchange 1030 is connected to at least one Manifold Channel 1024. Each Manifold Channel 1024 allows the passage of air from the Pressure Exchange 1030 into the Manifold Channel 1024 and from the Manifold Channel 1024 into a Choke 1010a, 1010b. Put another way, each Choke 1010a, 1010b is in fluid communication with the Pressure Exchange 1030 via a Manifold Channel 1024. Thus, air is able to flow through the Pressure Exchange Outlet 1036, down the Pressure Exchange 1030, into the Manifold Channel 1024 and into a Choke 1010a, 1010b. To aid in the flow of air through down the Pressure Exchange 1030, the Pressure Exchange Outlet 1036 may be formed to have a diameter larger than the other portions of the Pressure Exchange 1030. In some embodiments, the Pressure Exchange Outlet 1036 may have a frustoconical shape that extends downward into the Body 1002. To further aid in the flow of air down the Pressure Exchange 1030, a Mouth 1048 may be formed or recessed into the Top Surface 1004 such that the Pressure Exchange Outlet 1036 is disposed on a lower plane than the Choke Outlets 1014a, 1014b. Each Choke 1010a, 1010b has a Constricted Section 1016a, 1016b, i.e., an interior part of the choke which narrows. When a fluid (such as wine or alcohol) passes through a Choke 1010a, 1010b, a Venturi effect occurs at the Constricted Section 1016a, 1016b. This creates a lower fluid pressure at the Constricted Section 1016a, 1016b which causes air to be drawn from the Mouth 1048 and the Pressure Exchange Outlet 1036 through the Manifold Channel 1024 and out into the Choke 1010a, 1010b. The resulting air/fluid mixture is more aerated. For example, when Wine flows through a Choke 1010a, 1010b of a Venturi Aerator 1000, the Wine is aerated at the Constricted Section 1016a, 1016b. When wine passes through the Choke Inlet 1012a, 1012b, and into the Choke 1010a, 1010b, the Wine is aerated at the Constricted Section 1016a, 1016b where it draws air from the Manifold Channel 1024 and into the Choke 1010a, 1010b. The resulting Wine/air mixture then flows through the Choke 1010a, 1010b and exits the Body 1002 from a Choke Outlet 1014a, 1014b.

In the embodiments shown in FIG. 10A-10K, the Venturi Aerator 1000 includes one or more features formed on the Body 1002 configured to engage with the bottle 300. These features of the Body 1002 generally include an Upper Lip 1040 and one or more Ridges or Seats 1042a, 1042b configured to house one or more Seals 1044. The Upper Lip 1040 extends outward from the Top Surface 1004 of the Body 1002 to engage or sit on the opening of the Bottle 300 when the Venturi Aerator 1000 is fit inside the Bottle 300. In this manner, the Upper Lip 1040 helps prevent the Body 1002 from being positioned too far downward below the opening of the Bottle 300 which would make removal of the Venturi Aerator 1000 difficult. The one or more Seats 1042a, 1042b are formed on the side of the Body 1002 and are configured to house the Seal 1044. The one or more Seats 1042a, 1042b may also be referred to as a reduced diameter portion (i.e., a diameter smaller than that of the Body 1002) configured to receive the Seal 1044 such that an outer periphery of the Seal 1044 extends just beyond the diameter of the Body 1002. In this manner, once the Venturi Aerator 1000 has been inserted into the Bottle 300, the Seal 1044 forms a press- or interference-fit with the bottle such that the frictional engagement between the Body 1002 and the Bottle 300 can be maintained. In some embodiments, the Seal 1044 may be disposed on an upper Seat 1042a and positioned adjacent but below the Top Surface 1004 of the Body 1002. In other embodiments, the Seal 1044 may be disposed on a lower Seat 1042b and positioned adjacent but above the Bottom Surface 1006 of the Body 1002. However, in some other embodiments, a Seal 1044 may be provided in each of the upper and lower Seats 1042a, 1042b.

In the embodiments shown in FIG. 10A-10K, one or more features may be formed on the Body 1002 configured to help disengage the Venturi Aerator 1000 from the bottle 300. For example, an Undercut or Notch 1046 may be cut out of the Upper Lip 1040 and extend into the Top Surface of the Body 1002. The Notch 1046 is configured to provide an area where a tool (e.g., screwdriver, corkscrew, not shown) can be inserted and leveraged between the Body 1002 and Bottle 300 to help disengage the press-fit of the Seal 1044 and remove the Venturi Aerator 1000 from the bottle 300.

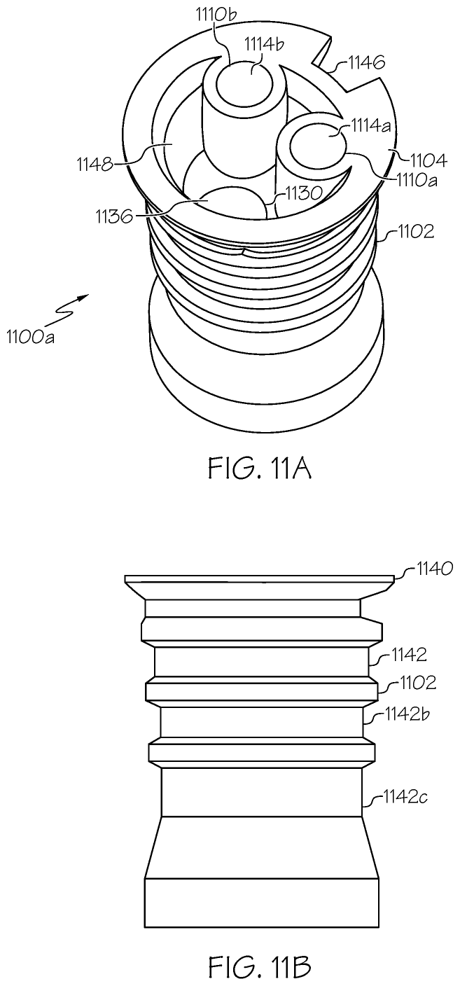

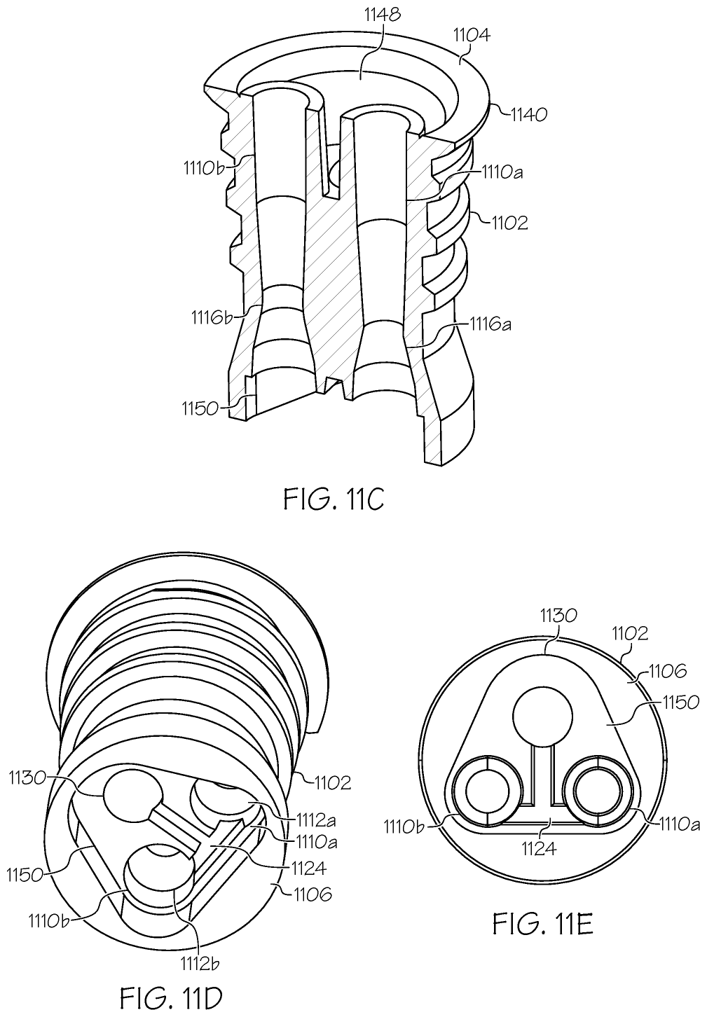

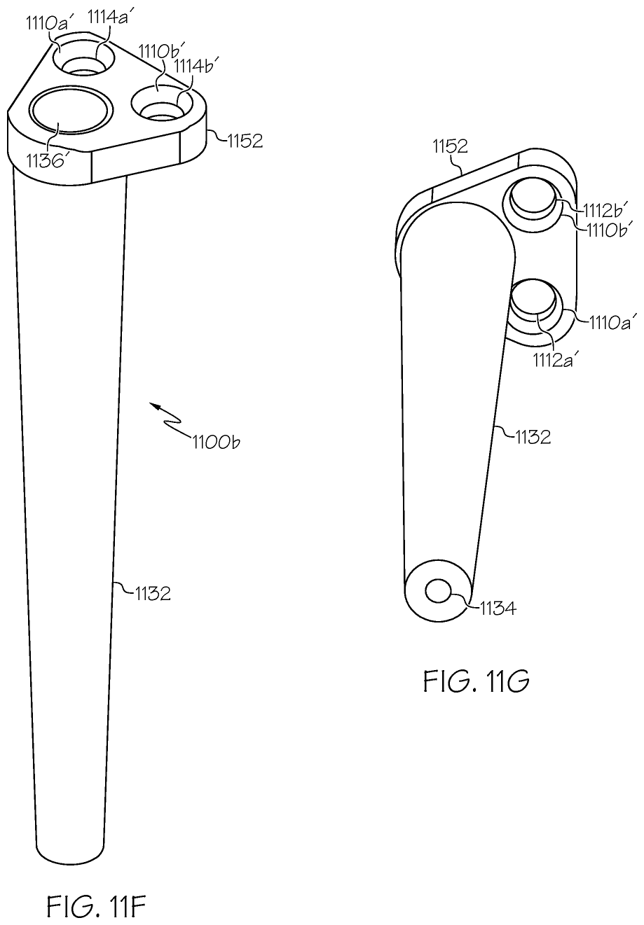

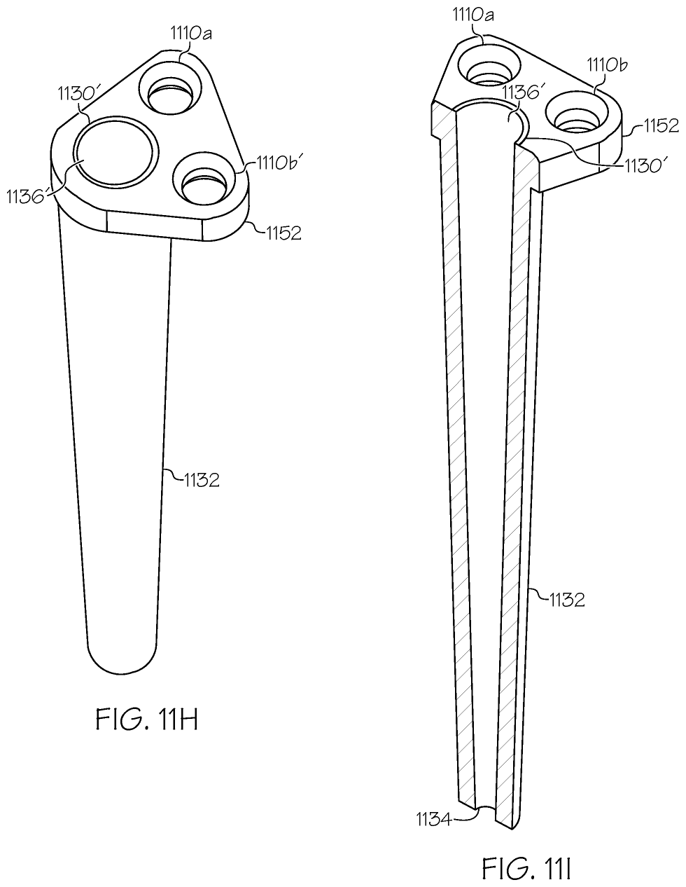

FIGS. 11A-11I depict one embodiment of a Venturi Aerator 1100 having a Body 1102, two Chokes 1110a, 1110b, and a Pressure Exchange Tube 1132. The Venturi Aerator 1000 has a Top Surface 1104 and a Distal Bottom Surface 1106. The Body 1102 has a generally cylindrical shape dimensionally sized to fit inside a bottle. In certain embodiments, the Body 1102 frictionally engages inside the neck of a wine or liquor bottle. In certain embodiments, the Body 1202 is dimensionally sized to match a Number 7, 8, 9 or 10 size cork. The Body 1102 may be constructed of any food grade material. In certain embodiments, the Body 1102 is made out of food grade plastics or food grade synthetic cork material such as low-density polyethylene (“LDPE”). The Body 1102 has a Top Surface 1104 and a distal Bottom Surface 1106. At least one Choke 1110a, 1110b extends through the Body 1102, with the Choke 1110a, 1110b, having a Choke Outlet 1114a, 1114b at the Top Surface 1104 and a Choke Inlet 1112a, 1112b at the Bottom Surface 1106. The Venturi Aerator 1100 has two Chokes 1110a and 1110b. As noted above, however, embodiments having only one Choke or a plurality of Chokes are possible. Each choke 1110a, 1110b has a Constricted Section 1116a, 1116b, i.e., an interior part of the choke which narrows. When a fluid (such as wine or alcohol) passes through a Choke 1110a, 1110b, a Venturi effect occurs at the Constricted Section 1116a, 1116b.

The Venturi Aerator 1000 in FIGS. 11A-11I also has at least one Pressure Exchange 1130 with at least one Pressure Exchange Outlet 1136 at the Top Surface 1104 of the Body 1102. The Pressure Exchange Tube 1132 also has a Pressure Exchange Inlet 1134 distal from the Bottom Surface 1106. This Pressure Exchange 1130 is in fluid communication with a Pressure Exchange Tube 1132 which extends outwards from the Bottom Surface 1106 of the Body 1102. The purpose of the Pressure Exchange 1130 is to equalize the pressure inside the bottle with the outside air pressure. This allows for a smooth flow of liquid as air bubbles into the bottle through the Pressure Exchange Tube 1132 as liquid pours out of the Bottle. In certain embodiments, the Pressure Exchange Tube 1132 extends into the body-portion of a bottle, and more particularly, extends along the length of the neck of the bottle and stops at the beginning of the shoulder of the bottle. In certain embodiments, the Pressure Exchange Tube 1132 extends approximately one inch beyond the Body 1102 of the Venturi Aerator 1100. In certain embodiments, the Body 1102 of the Venturi Aerator 1100 is approximately 3¼ inches in length. The Pressure Exchange Tube 1132 may be formed of any food-grade material. In the preferred embodiment, the Pressure Exchange Tube 1132 is made of a plastic so that it is shatter-resistant.

In the embodiment shown in FIGS. 11A-11I, the two Chokes 1110a, 1110b and the Pressure Exchange Outlet 1136 are generally distributed radially around a central longitudinal axis of the Body 1102. In other embodiments, however, each Choke and the Pressure Exchange Outlet could be located in other configurations. The relative size of each Choke Outlet 1114a, 1114b and Pressure Exchange Outlet 1136 can be varied. In the embodiment shown in FIGS. 11A-11I, each Choke Outlet 1114a, 1114b is of the same size and is generally smaller than the Pressure Exchange Outlet 1136. In certain alternative embodiments, each orifice in the Top Surface 1104 of the Body 1102 may be the same or varying relative sizes.

In the embodiments shown in FIG. 11A-11I, the Venturi Aerator 1100, similar to the Venturi Aerator 1000 embodiment described above, does not include a separate Air Manifold. Rather, the Pressure Exchange 1130 is configured to act as the Air Manifold for the Venturi Aerator 1100. The Pressure Exchange 1130 is connected to at least one Manifold Channel 1124. Each Manifold Channel 1124 allows the passage of air from the Pressure Exchange 1130 into the Manifold Channel 1124 and from the Manifold Channel 1124 into a Choke 1110a, 1110b. Put another way, each Choke 1110a, 1110b is in fluid communication with the Pressure Exchange 1130 via a Manifold Channel 1124. Thus, air is able to flow through the Pressure Exchange Outlet 1136, down the Pressure Exchange 1130, into the Manifold Channel 1124 and into a Choke 1110a, 1110b. To aid in the flow of air through down the Pressure Exchange 1130, the Pressure Exchange Outlet 1136 may be formed to have a diameter larger than the other portions of the Pressure Exchange 1130. In some embodiments, the Pressure Exchange Outlet 1136 may have a frustoconical shape that extends downward into the Body 1102. To further aid in the flow of air down the Pressure Exchange 1130, a Mouth 1148 may be formed or recessed into the Top Surface 1104 such that the Pressure Exchange Outlet 1136 is disposed on a lower plane than the Choke Outlets 1114a, 1114b. Each Choke 1110a, 1110b has a Constricted Section 1116a, 1116b, i.e., an interior part of the choke which narrows. When a fluid (such as wine or alcohol) passes through a Choke 1110a, 1110b, a Venturi effect occurs at the Constricted Section 1116a, 1116b. This creates a lower fluid pressure at the Constricted Section 1116a, 1116b which causes air to be drawn from the Mouth 1148 and the Pressure Exchange Outlet 1136 through the Manifold Channel 1124 and out into the Choke 1110a, 1110b. The resulting air/fluid mixture is more aerated. For example, when Wine flows through a Choke 1110a, 1110b of a Venturi Aerator 1100, the Wine is aerated at the Constricted Section 1116a, 1116b. When wine passes through the Choke Inlet 1112a, 1112b, and into the Choke 1110a, 1110b, the Wine is aerated at the Constricted Section 1116a, 1116b where it draws air from the Manifold Channel 1124 and into the Choke 1110a, 1110b. The resulting Wine/air mixture then flows through the Choke 1110a, 1110b and exits the Body 1102 from a Choke Outlet 1114a, 1114b.

In the embodiments shown in FIG. 11A-11I, the Venturi Aerator 1100 includes one or more features formed on the Body 1102 configured to engage with a bottle (not shown). These features of the Body 1102 generally include an Upper Lip 1140 and one or more Ridges or Seats 1142, 1142b, 1142c configured to house one or more Seals (not shown). The Upper Lip 1140 extends outward from the Top Surface 1104 of the Body 1102 to engage or sit on the opening of a Bottle when the Venturi Aerator 1100 is fit inside the Bottle. In this manner, the Upper Lip 1140 helps prevent the Body 1102 from being positioned too far downward below the opening of the Bottle which would make removal of the Venturi Aerator 1100 difficult. The one or more Seats 1142, 1142b, and 1142c are formed on the side of the Body 1102 and are configured to house the Seal (not shown). The one or more Seats 1142, 1142b, and 1142c may also be referred to as a reduced diameter portion (i.e., a diameter smaller than that of the Body 1102) configured to receive the Seal such that an outer periphery of the Seal extends just beyond the diameter of the Body 1102. In this manner, once the Venturi Aerator 1100 has been inserted into the Bottle, the Seal forms a press- or interference-fit with the bottle such that the frictional engagement between the Body 1102 and the Bottle can be maintained. In some embodiments, the Seal may be disposed on an upper Seat 1142 and positioned adjacent but below the Top Surface 1104 of the Body 1102. In additional embodiments, the Seal may be disposed on a middle seat 1142b and positioned generally centrally between the Top Surface 1104 and Bottom Surface 1106 of the Body 1102. In other embodiments, the Seal may be disposed on a lower Seat 1142c and positioned adjacent but above the Bottom Surface 1106 of the Body 1102. However, in some other embodiments, a Seal may be provided in each of the upper, middle, and lower Seats 1142, 1142b, 1142c.

In the embodiments shown in FIG. 11A-11I, one or more features may be formed on the Body 1102 configured to help disengage the Venturi Aerator 1100 from the bottle. For example, an Undercut or Notch 1146 may be cut out of the Upper Lip 1140 and extend into the Top Surface of the Body 1102. The Notch 1146 is configured to provide an area where a tool (e.g., screwdriver, corkscrew, not shown) can be inserted and leveraged between the Body 1102 and Bottle to help disengage the press-fit of the Seal and remove the Venturi Aerator 1100 from the bottle.

As mentioned above, in certain embodiments, the Pressure Exchange Tube may be separately manufactured then attached to the Body to form the Venturi Aerator. In the embodiments shown in FIGS. 11A-11I, the Pressure Exchange Tube 1132 is configured as a separate component from the Body 1102 and is configured to be press-fit into the Bottom Surface 1006 of the Body 1102 to form the Venturi Aerator 1100. More particularly, a Cavity or Recess 1150 is formed into the Bottom Surface 1006 of the Body 1102 that is configured to receive a corresponding Insert 1152 formed on the top of the Pressure Exchange Tube 1132 (i.e., on the end opposite to the Pressure Exchange Inlet 1134). That is, the Insert 1152 of the Pressure Exchange Tube 1132 is configured to be press-fit into the Recess 1150. Moreover, the Insert 1152 of the Pressure Exchange Tube 1132 is formed to have an arrangement of Insert Chokes 1110a′, 1110b′ and an Insert Pressure Exchange Outlet 1136′ which form part of the corresponding Chokes 1110a, 1110b and Pressure Exchange Outlet 1136 on the Body 1102 when the Insert 1152 is press-fit into the Recess 1150. In this regard, the Insert 1152 of the Pressure Exchange Tube 1132 includes a first Insert Choke 1110a′ having an Insert Inlet 1112a′ and an Insert Outlet 1114a′ and a second Insert Choke 1110b′ having an Insert Inlet 1112b′ and an Insert Outlet 1114b′. The Insert Outlets 1114a′, 1114b′ are configured to fluidly connect to the Choke Inlets 1112a, 1112b, respectively, once the Insert 1152 is press-fit into the Recess 1150, thereby forming continuous chokes between the Body 1102 and Pressure Exchange Tube 1132. Moreover, the Insert 1152 includes an Insert Pressure Exchange Outlet 1136′ which is configured to fluidly connect with the Pressure Exchange 1130 of the Body 1102 once the Insert 1152 is press-fit into the Recess 1150, thereby forming a continuous pressure exchange between the Body 1102 and the Pressure Exchange Tube 1132.

From the above, it should be understood that a Venturi Aerator device is described which can be used in connection with various methods of filling a bottle and of aerating a bottled liquid. For example, in one example embodiment, a method of filling a bottle includes providing a sterilized bottle (e.g., Bottle 300, 400, and/or 600 described above); (b) inserting a sterilized Venturi Aerator (e.g. Venturi Aerator 100, 400, 500, 700, 800, 900, 1000, and/or 1100 described above) into the bottle; (c) filling the bottle with a liquid; and (d) sealing the bottle. The method of filling a bottle further includes: (a1) wherein the bottle is a wine bottle. The method of filling a bottle further includes: (b1) inserting the sterilized Venturi Aerator into the neck of the bottle. The method of filling a bottle further includes: (c1) wherein the liquid is a beverage. The method of filling a bottle further includes: (c2) wherein the liquid is wine. The method of filling a bottle further includes: (c3) wherein the liquid is a distilled spirit. The method of filling a bottle further includes: (d1) wherein the bottle is sealed with a closure (e.g., Closure 202, such as a cork or a synthetic cork). The method of filling a bottle further includes: (d2) wherein the bottle is sealed with a screw cap (e.g., Screw Cap 408 described above).

In another example embodiment, a method of filling a bottle includes: (a) providing a sterilized bottle (e.g., Bottle 300, 400, and/or 600 described above); (b) filing the sterilized bottle with a liquid; (c) inserting a sterilized Venturi Aerator (e.g. Venturi Aerator 100, 400, 500, 700, 800, 900, 1000, and/or 1100 described above) into the bottle; and (d) sealing the bottle. The method of filling a bottle further includes: (a1) wherein the bottle is a wine bottle. The method of filling a bottle further includes: (b1) wherein the liquid is a beverage. The method of filling a bottle further includes: (b2) wherein the liquid is wine. The method of filling a bottle further includes: (b3) wherein the liquid is a distilled spirit. The method of filling a bottle further includes: (c1) the inserting the sterilized Venturi Aerator into the neck of the bottle. The method of filling a bottle further includes: (d1) wherein the bottle is sealed with a closure (e.g., Closure 202, such as a cork or a synthetic cork). The method of filling a bottle further includes: (d2) wherein the bottle is sealed with a screw cap (e.g. Screw Cap 408 described above).

In an additional example embodiment, a method of filling a bottle includes: (a) providing a bottle (e.g. Bottle 300, 400, and/or 600 described above), (b) inserting a Venturi Aerator (e.g. Venturi Aerator 100, 400, 500, 700, 800, 900, 1000, and/or 1100 described above) into the bottle; (c) sterilizing the bottle and Venturi Aerator assembly; (d) filing the sterilized bottle with a liquid; and (e) sealing the bottle. The method of filling a bottle further includes: (a1) wherein the bottle is a wine bottle. The method of filling a bottle further includes: (b1) the Venturi Aerator is inserted into the neck of the bottle. The method of filling a bottle further includes: (d1) wherein the liquid is a beverage. The method of filling a bottle further includes: (d2) wherein the liquid is wine. The method of filling a bottle further includes: (d3) wherein the liquid is a distilled spirit. The method of filling a bottle further includes: (e1) wherein the bottle is sealed with a closure (e.g., Closure 202, such as a cork or a synthetic cork). The method of filling a bottle further includes: (e2) wherein the bottle is sealed with a screw cap (e.g., Screw Cap 408 described above).

In yet another example embodiment, a method of aerating a bottled liquid includes: (a) providing a pre-filled bottle (e.g., Bottle 300, 400, and/or 600 described above) of liquid; (b) opening the bottle; (c) inserting a Venturi Aerator (e.g. Venturi Aerator 100, 400, 500, 700, 800, 900, 1000, and/or 1100 described above) into the bottle; and (d) pouring the liquid through the Venturi Aerator. The method of aerating a bottled liquid further includes: (a1) wherein the bottle is a wine bottle. The method of aerating a bottled liquid further includes: (b1) wherein the bottle is opened by removing a closure (e.g., Closure 202, such as a cork or a synthetic cork). The method of aerating a bottled liquid further includes: (b2) wherein the bottle is opened by removing a screw cap (e.g., Screw Cap 408 described above). The method of aerating a bottled liquid further includes: (d1) wherein the liquid is a beverage. The method of aerating a bottled liquid further includes: (d2) wherein the liquid is wine. The method of aerating a bottled liquid further includes: (d3) wherein the liquid is a distilled spirit.

In yet an additional example embodiment, a method of aerating a liquid includes passing the liquid through a Venturi Aerator (e.g. Venturi Aerator 100, 400, 500, 700, 800, 900, 1000, and/or 1100 described above). The method of aerating a liquid further includes: wherein the liquid is a beverage. The method of aerating a liquid further includes: wherein the liquid is wine. The method of aerating a liquid further includes: wherein the liquid is a distilled spirit.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A beverage aerator device, comprising:
a body that has a top surface and a bottom surface;
at least one choke that extends through the body and has a choke inlet at the bottom surface of the body and a choke outlet at the top surface of the body;
a pressure exchange that extends through the body and has a pressure exchange outlet at the top surface of the body; and
a pressure exchange tube that is in fluid communication with the pressure exchange and has a pressure exchange inlet distal from the bottom surface of the body.

2. The device of claim 1, further comprising an air manifold that extends partially into the body and has a manifold aperture at the top surface of the body.

3. The device of claim 2, further comprising a manifold channel that connects the at least one choke to the air manifold.

4. The device of claim 1, wherein the at least one choke has a constricted section disposed adjacent to the choke inlet.

5. The device of claim 1, wherein the body is cylindrical in shape and dimensionally sized to match a number 7, 8, 9, 10 size cork.

6. The device of claim 1, wherein the body is made of a food grade material.

7. The device of claim 1, further comprising a closure that abuts the top surface of the body.

8. The device of claim 1, further comprising a manifold channel that connects the at least one choke to the pressure exchange.

9. The device of claim 1, further comprising an upper lip extending outward from the top surface of the body.

10. The device of claim 1, wherein the body further comprises:
one or more seats formed on the side of body; and
a seal housed in the one or more seats of the body.

11. The device of claim 1, further comprising an undercut that extends into the top surface of the body.

12. The device of claim 1, wherein the pressure exchange tube extends outwards from the bottom surface of the body.

13. The device of claim 1, wherein the body further comprises a recess formed into the bottom surface of the body and wherein the pressure exchange tube further comprises an insert formed on top of the pressure exchange tube at an end opposite to the pressure exchange inlet that is received in the recess of the body.

14. The device of claim 13, wherein the insert of the pressure exchange tube is press-fit into the recess of the body.

15. A beverage aerator device, comprising:
a cylindrical body that has a top surface and a bottom surface, wherein the cylindrical body is frictionally engaged inside a neck of a bottle;
a pressure exchange tube extending outwards from the bottom surface of the cylindrical body that has a pressure exchange inlet distal from the bottom surface of the cylindrical body and a pressure exchange outlet at the top surface of the cylindrical body, wherein the pressure exchange tube extends into a body-portion of the bottle; and
at least one choke that extends through the cylindrical body, the at least one choke having a choke inlet at the bottom surface of the cylindrical body, a choke outlet at the top surface of the cylindrical body, and a constricted section disposed adjacent to the choke inlet.

16. The device of claim 15, further comprising an air manifold that extends partially into the body, the air manifold having a manifold aperture at the top surface of the cylindrical body and a manifold channel that connects the at least one choke to the air manifold.

17. The device of claim 15, wherein the at least one choke is in fluid communication with the pressure exchange tube via a manifold channel.

18. A method of using a beverage aerator device, comprising:
inserting the beverage aerator device into a neck of a bottle containing a fluid, the beverage aerator device comprising:
a body that has a top surface and a bottom surface;
a pressure exchange tube that has a pressure exchange inlet distal from the bottom surface of the body and a pressure exchange outlet at the top surface of the body; and
at least one choke that extends through the body and includes a choke inlet at the bottom surface of the body, a choke outlet at the top surface of the body, and a constricted section disposed adjacent to the choke inlet;
causing the fluid to flow from the bottle into the choke inlet of the at least one choke of the body;
aerating the fluid at the constricted section of the at least one choke to create a mixture of the fluid with air; and
pouring the mixture of the fluid with the air from the choke outlet of the at least one choke of the body.

19. The method of claim 18, further comprising inserting a closure into the neck of the bottle above the body of the beverage aerator device.

20. The method of claim 18, wherein the bottle is a screw-cap bottle with a screw-cap disposed on the bottle above the beverage aerator device.
